(19) United States
(12) Patent Application Publication
(10) Pub. No.: US 2003/0091708 A1
(43) Pub. Date: May 15, 2003

(54) Irradiation in low oxygen environment

(76) Inventor: Anthony J.M. Garwood, Mercer Island, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/320,863

(22) Filed: Dec. 16, 2002

Related U.S. Application Data
(63) Continuation of application No. 09/724,287, filed on Nov. 28, 2000.
Application No. 09/724,287 is a continuation-in-part of application No. PCT/US00/29038, filed on Oct. 19, 2000.
Application No. 09/724,287 is a continuation-in-part of application No. 09/550,399, filed on Apr. 14, 2000, now abandoned.
Application No. 09/550,399 is a continuation-in-part of application No. 09/392,074, filed on Sep. 8, 1999, now abandoned.
Application No. 09/392,074 is a continuation of application No. 09/039,150, filed on Mar. 13, 1998, now abandoned.
(60) Provisional application No. 60/040,556, filed on Mar. 13, 1997.

(51) Int. Cl. C12C 3/04

(52) U.S. Cl. 426/392

(57) ABSTRACT

Irradiation of food is done in a low oxygen environment to prevent oxidation.

### CROSS-REFERENCES TO RELATED APPLICATIONS

This application is a continuation of application Ser. No. 09/724,287, filed Nov. 28, 2000, which in turn is a continuation-in-part of Application No. PCT/US00/29038, filed Oct. 19, 2000, now abandoned, and is a continuation-in-part of application Ser. No. 09/550,399, filed Apr. 14, 2000, which in turn is a continuation-in-part of application Ser. No. 09/392,074, filed Sep. 8, 1999, now abandoned, which in turn is a continuation of application Ser. No. 09/039,150, filed Mar. 13, 1998, now abandoned, which in turn claims the benefit of U.S. Provisional Application No. 60/040,556, filed Mar. 13, 1997, and claims the benefit of U.S. Provisional Application Nos. 60/129,595, filed Apr. 15, 1999; 60/141,569, filed Jun. 29, 1999; 60/144,400, filed Jul. 16, 1999; 60/148,227, filed Jul. 27, 1999; 60/149,938, filed Aug. 19, 1999; 60/152,677, filed Sep. 7, 1999; 60/154,068, filed Sep. 14, 1999; 60/160,445, filed Oct. 19, 1999; and 60/175,372, filed Jan. 10, 2000. All of the above applications are herein expressly incorporated by reference for all purposes.

### FIELD OF THE INVENTION

The present invention relates to irradiation in a low oxygen environment.

### BACKGROUND OF THE INVENTION

A problem with electron beam irradiation of food is the undesired oxidation of the food. One embodiment of this invention provides an advantage over the prior art.

### SUMMARY OF THE INVENTION

An embodiment of the invention includes a method and apparatus for grinding boneless beef directly into an enclosed chamber that has been filled with a suitable gas such as CO₂ and which substantially excludes oxygen from contacting the ground beef. In one embodiment the conditioned ground beef may be exposed to a suitable beam of electrons by locating an electron beam generator in such a manner that the suitable beam of electrons produced therewith, is directed at and through a stream of grinds while the grinds are passing through a tube. Electron beam sterilization is used on fresh ground beef, which is in a low oxygen environment to prevent over-oxidation.

Extruding ground beef in a stream of grinds by pumping through an enclosed conduit with an exit end and a selected cross sectional area and profile that is substantially similar to typical beef patty, at a velocity that is adjustable while maintaining pumping at a substantially constant rate. Pressurizing a stream of ground beef in a conduit at a selected pressure and compressing any voids such that CO₂ gas contained therein dissolves into the stream of ground beef. Maintaining ground beef at a suitable temperature, and interfacing with a packaging system and packaging fresh meat patties without exposure to air while maintained at a suitable temperature.

Trays and packaging apparatus according to the present invention can incorporate either a low oxygen modified atmosphere or alternatively a high oxygen modified atmosphere. A high oxygen modified atmosphere may include a blend of gases including 20% carbon dioxide, 70% oxygen and 10% nitrogen. Part of this blend of gas may include some residual ambient atmospheric gases.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a cross section illustration of an apparatus according to the present invention;

FIG. 2 shows a cross section illustration of an apparatus according to the present invention;

FIG. 3 shows a cross section illustration of an apparatus according to the present invention;

FIG. 4 shows a side elevation illustration of an apparatus according to the present invention;

FIG. 5 shows a side elevation, cross sectional illustration of an apparatus according to the present invention;

FIG. 6 shows a cross-sectional view of an apparatus portion of FIG. 5 taken along line 6;

FIG. 7 shows a cross-sectional view of an apparatus portion of FIG. 5 taken along line 7;

FIG. 8 shows an apparatus for grinding and processing meat constructed according to the present invention;

FIG. 9 shows an apparatus for grinding and processing meat constructed according to the present invention;

FIG. 10 shows a cross-sectional view of an apparatus portion of FIG. 9;

FIG. 11 shows a cross-sectional view of an apparatus portion of FIG. 9;

FIG. 12 shows a front plan view of a manifold constructed according to the present invention;

FIG. 13 shows a side plan view of the manifold of FIG. 12;

FIG. 14 shows a cross-sectional view of an apparatus for grinding and processing meat according to the present invention;

FIG. 15 shows a cross-sectional view of an apparatus for processing meat constructed according to the present invention;

FIG. 16 shows a side plan view of an apparatus portion of FIG. 15;

FIG. 17 shows a cross-sectional view of an apparatus portion of FIG. 16 taken along line 17;

FIG. 18 shows a cross-sectional view of an apparatus portion of FIG. 17 taken along line 190;

FIG. 19 shows a top plan view of a tube structure according to the present invention;

FIG. 20 shows a cross-sectional view of an apparatus portion having three meat processing tubes, constructed according to the present invention;

FIG. 21 shows a top plan view of a packaging and slicing apparatus having a tunnel, constructed according to the present invention;

FIG. 22 shows a cross-sectional view of the apparatus of FIG. 21 taken along line 22;

FIG. 23 shows a schematic view of a meat processing and packaging apparatus constructed according to the present invention;

FIG. 24 shows a schematic view of a meat processing and packaging apparatus constructed according to the present invention;

FIG. 25 shows a cross-sectional view of a web material constructed according to the present invention;

FIG. 26 shows a perspective view of an over wrapping web material constructed according to the present invention;

FIG. 27 shows a perspective view of an over wrapped package constructed according to the present invention;

FIG. 28 shows a schematic view of an apparatus portion constructed according to the present invention;

FIG. 29 shows a top plan view of an apparatus portion constructed according to the present invention;

FIG. 30 shows a schematic view of an equipment layout constructed according to the present invention;

FIG. 31 shows a cross-sectional view of a master container vacuum chamber constructed according to the present invention;

FIG. 32 shows a schematic illustration of an embodiment of a plant layout according to the present invention;

FIG. 33 shows a schematic illustration of an embodiment of a tray packaging layout according to the present invention;

FIG. 34 shows a schematic illustration of an embodiment of a plant layout according to the present invention;

FIG. 35 shows a schematic illustration of a section of the plant for packaging trays with meat products;

FIG. 36 shows a sectional view of the tray de-nesting apparatus portion of FIG. 35 before the flap ends have been bonded to the tray walls; and

FIG. 37 shows a schematic illustration of an embodiment of an apparatus for forming webs according to the present invention.

### DETAILED DESCRIPTION OF THE PREFERRED EMBODIMENT

As used herein, the following terms take the following meaning, unless otherwise indicated.

The term “case ready” refers to retail packaged fresh meats (that were typically formerly prepared at the supermarket) that has been packaged ready for retail sale from the meat case at a place of production remote from the supermarket.

The term “high oxygen modified atmosphere” refers to a blend of gases that includes some or all of the naturally occurring atmospheric gases but in proportions that are different to air and including a high level of oxygen which may be greater than 40%. Such an example would be a gas comprising 80% oxygen and 20% carbon dioxide, however in virtually all applications a residual quantity of nitrogen remains in the sealed “high oxygen modified atmosphere” package.

The term “low oxygen” or “no oxygen” modified atmosphere” refers to a blend of gases that includes some or all of the naturally occurring atmospheric gases (except oxygen) but in proportions that are different to air and including a low (or zero level of oxygen) which may be less than 300-500 parts per million.

The term “MAP” refers to modified atmosphere packaging.

The term “CAP” refers to controlled atmosphere packaging.

The term “Epsilon GMS-40” or “GMS-40” refers to an apparatus that can be used to measure the fat and/or lean content of pumpable ground meats. The GMS-40 is manufactured and supplied by Epsilon Industries, of Austin, Tex. Additional information is available on web site: www.epsilon-gms.com.

The term “AVS-ET system” refers to a system that can be used to identify the composition of boneless meats. The system can identify quantities of fat, muscle/lean tissue, contaminants, bone, metal inclusions and other matter that is transferred, in a continuous stream, through a conduit and into and then away from the AVS-ET system. The system operates preferably when the continuous stream is exclusive of any voids such as pockets of air. The system is manufactured and supplied by Holmes Newman Associates, 4221 Fallsbrae Road, of Fallbrook, Calif., 92028.

The term “statiflo blending devices” refers to a continuous, static and enclosed material blending device that can introduce gases such as CO₂ to the blended material. STATIFLO is a registered trademark of Statiflo International, The Crown Center, Bond Street, Macclesfield, Cheshire SK116QS, United Kingdom. Information is available on web site: sales@statiflo.co.uk.

The term “blending devices” refers to a continuous, static and enclosed material blending device that can be used to continuously blend such perishable goods as ground meats that comprise substantially two components of fat and lean meat and may also be used to introduce gases such as CO₂ to the blended materials.

The term “shelf life” refers to the period of time between the date of retail packaging of perishable goods (that are slowly deteriorating) of acceptable quality and a subsequent point in time or date, prior to the perishable goods having deteriorated to an unacceptable condition.

The term “PP” refers to polypropylene.

The term “EPS” refers to expanded polystyrene.

The term “pPVC” refers to plasticized polyvinylchloride.

The term “PET,” polyester or “APET” refers to amorphous polyethylene terephthalate.

The term “heat activated adhesives (or coating)” refers to adhesives that become active and capable of bonding substances together when heated to a suitable temperature that otherwise, at ambient temperature, will not bond.

The term “OTR” refers to oxygen transmission rate.

The term “perishable goods” or “goods” refers to any perishable foods such as sliced beef or other fresh meats, ground meats, poultry pieces etc.

The term “liquids and oils” refers to water, liquids, blood, purge, liquid animal fats and oils and the like.

The term “master container” generally refers to a substantially gas barrier container that can be filled with finished packages, evacuated of substantially all atmospheric air and filled with any suitable gas. However, said “master container” may also be gas permeable if so desired.

The terms “suitable substance”, “suitable gas” or “suitable gases” refer to any gas or blend of gases, provided at any pressure (suitable pressure) such as 45% oxygen and 55% carbon dioxide at ambient pressure or any other blend of gases. A suitable gas may include a blend of carbon dioxide and nitrogen and oxygen with residual atmospheric gases in any relative proportions. Examples are provided, but are not restricted to any of the following:

A blend of gases including argon, carbon dioxide, nitrogen and a quantity of oxygen that does not exceed 5% and is not less than 5 PPM (parts per million).

Air that has been filtered to remove substantially all oxygen therefrom.

Carbon dioxide and nitrogen in any relative proportions.

Carbon dioxide and oxygen where oxygen does not exceed 5% and is not less than 5 PPM.

Carbon dioxide and a quantity of oxygen that does not exceed 5% and is not less than 5 PPM (parts per million).

Nitrogen and a quantity of oxygen that does not exceed 5% and is not less than 5 PPM (parts per million).

A blend of inert gases and a quantity of oxygen that does not exceed 5% and is not less than 5 PPM (parts per million).

A blend of pentane and nitrogen in any relative proportions and a quantity of oxygen that does not exceed 5% and is not less than 5 PPM (parts per million).

A blend of propane and nitrogen in any relative proportions and a quantity of oxygen that does not exceed 5% and is not less than 5 PPM (parts per million).

A blend of butane and nitrogen in any relative proportions and a quantity of oxygen that does not exceed 5% and is not less than 5 PPM (parts per million).

A blend of a CFC and nitrogen in any relative proportions and a quantity of oxygen that does not exceed 5% and is not less than 5 PPM (parts per million).

A blend of an HCFC and nitrogen in any relative proportions and a quantity of oxygen that does not exceed 5% and is not less than 5 PPM (parts per million).

A blend of methane and nitrogen in any relative proportions and a quantity of oxygen that does not exceed 5% and is not less than 5 PPM (parts per million).

A blend of hydrogen sulfide and nitrogen in any relative proportions and a quantity of oxygen that does not exceed 5% and is not less than 5 PPM (parts per million).

A blend of carbon monoxide and nitrogen in any relative proportions and a quantity of oxygen that does not exceed 5% and is not less than 5 PPM (parts per million).

A blend of sulfur dioxide and nitrogen in any relative proportions and a quantity of oxygen that does not exceed 5% and is not less than 5 PPM (parts per million).

A gas including 100% carbon dioxide

A substance or agent including one or more of the following: isoascorbic acid, ascorbic acid, citric acid, erythorbic acid, lactic acid, succinic acid or mixtures of salts thereof. Glycerol monolaurate, potassium sorbate, sodium sorbate, sodium iodoacetate, potassium acetate, iodoacetomide, potassium iodoacetate, sodium acetate or mixtures or acidic solutions thereof.

The term “suitable gas pressure” or “water pressure” refers to any pressure that is suitable for the application and may be controlled within any of the following pressure ranges, or any other suitable pressure:

Suitable gas pressure includes:

gas at a pressure of 1 PSI to 14 PSI.

gas at a pressure of up to 13 PSI.

gas at a pressure of 13 PSI to 50 PSI.

gas at a pressure of 50 PSI to 80 PSI.

gas at a pressure of 80 PSI to 120 PSI.

gas at a pressure of 120 PSI to 200 PSI.

gas at a pressure of 200 PSI to 500 PSI.

gas at a pressure above 500 PSI.

Suitable water pressure:

water at a pressure of 1 PSI to 14 PSI.

water at a pressure of up to 13 PSI.

water at a pressure of 13 PSI to 50 PSI.

water at a pressure of 50 PSI to 80 PSI.

water at a pressure of 80 PSI to 120 PSI.

water at a pressure of 120 PSI to 200 PSI.

water at a pressure of 200 PSI to 500 PSI.

water at a pressure above 500 PSI.

The term “suitable gas temperature” or “suitable water temperature” refers to any temperature that is suitable for the application and may be controlled within any suitable temperature ranges for any suitable period of time, or at any other suitable temperature. Suitable temperature also includes a temperature range which may be a pasteurizing temperature range such as maintaining a product such as a beef primal within a temperature range of not less than 138.5 degrees F. to 140 degrees F. and for a suitable period of time.

Bond or Bonding refers to sealing or welding of two or more surfaces together by any suitable means such as with any suitable adhesive, RF welding, ultrasonic welding heat sealing, or any other suitable means.

Hermetic seal refers to a seal or bonding of two or more surfaces of any suitable material together by any suitable means to provide an enclosed space and wherein said enclosed space is rendered fully enclosed in such a manner that will substantially inhibit the passage or communication of any substance such as gas, air or liquids from within said enclosed space to and with the exterior of said enclosed space.

Pre-Form refers to a thermoformed or suitably fabricated packaging component that has been arranged with one or more hinged flaps that can be folded or bonded to produce a useful packaging tray or container for goods. Pre-forms may also comprise more than one component that are subsequently assembled together to provide one or more components but where the number of items remaining after assembly are less than the number of components from which the remaining items are produced.

“Valve” refers to any suitable valve to suit the particular needs of the disclosed application. Valves may be arranged to control the flow of gas, liquid, or solids such as powders and can be selected from manufacturers skilled in the arts of valve manufacturing of any particular valve from any suitable materials.

“CPU” refers to a central processing unit or any suitable computer processor suitable for the application such as are contained in most personal computers (PC).

“HHRCD” refers to a hand held remote controlling device such as a PALM PILOT®.

“Fat” content is a component of meat and may mean the measured fat content of a quantity of boneless meat harvested from any species of slaughtered animal such as beef.

“Meat” can mean any meat harvested from any species of slaughtered animal wherein the meat comprises several components but generally including water, fat, oils, and protein in relative quantities that are not precisely known at the time of harvesting and must be measured to determine the precise ratio of each component.

Trays are described in the referenced patent applications at the beginning of this application. Any tray disclosed in these applications can be used with the processes herein described below.

One embodiment of the present invention provides methods, systems and apparatus to automatically and continuously grind, condition and blend ground meat products with improved accuracy of muscle tissue to fat tissue ratio, so as to minimize losses. The ground meat can then be packaged in suitable packaging that will enhance the keeping qualities of the products and provide a safer method of delivering the goods to consumers.

Referring to FIG. 8, a cross-sectional view of a grinding head 1300 constructed according to the present invention is shown. Grinding head 1300 is attached to a source for the carbonation of liquids and water contained in ground meats. Meat 1310 is processed through grinding head 1300 of a meat grinder 1302 and deposited into vessel 1304. Vessel 1304 is substantially sealed from the external atmosphere. Entry point 1306 and exit point 1308 are such that when compacted meat 1310 fills the grinding head 1300 adjacent to the cutter 1312 and similarly compacted ground meat 1316 fills the exit point 1308 of vessel 1304 adjacent to the end of screw-auger 1314, the vessel 1304 can be filled with a gas such as carbon dioxide under pressure. Pressure is kept above ambient atmospheric pressure therefore assisting the dissolving process of carbon dioxide into water in meat. Screw-auger 1314 is attached to a driver (not shown) and rotated so that the ground meat is carried forward and as it travels down the length of the screw auger 1314, the space between the tapered flights 1320 of the screw auger 1314 gradually is reduced, thereby compressing the ground meat just prior to ejection at exit point 1308, thus providing a seal of the vessel 1304 from ambient atmosphere.

This embodiment provides a cost effective method of increasing the pressure of carbon dioxide and elevating the quantity of dissolved carbon dioxide in water and ground meat to a desirable level. Gas provided under pressure into the vessel may include a suitable blend of carbon dioxide and other gases such as nitrogen, stabilized chlorine dioxide (stabilized chlorine dioxide brand name Oxine), helium, and other inert gases, but substantially excluding oxygen, and including an amount of carbon dioxide of about 5% to about 100% by volume or weight.

One embodiment of screw-auger 1314 is shown but alternates may be arranged in other configurations such as when connected directly to and parallel with screw auger 1318 and housed in a tube that has an internal diameter slightly larger than the outside diameter of screw auger 1314, that is also in line and parallel with screw auger 1318. Such an arrangement passes ground beef through a pressure box or vessel and exposes the ground beef to carbon dioxide or other suitable gases at a gas pressure above ambient atmospheric pressure.

Suitable blends of gases can be produced and/or blended at the point of use and injected into vessel 1304 and grinding head 1300 at ports 1322. A stainless steel or plastic extension tube is fitted to the flanges of the “downstream” egress/exit point of the pressure box (so as to allow all ground meat to pass through the tube) and the blend of gases is injected into the tube so as to substantially expel atmospheric gases and oxygen from the tube such that the blend of gases remains in contact with the meat within the tube. The tube may house an auger type screw arrangement to transfer ground meat inside the tube. The auger has apertures and holes drilled that connect to a pressurized supply of gas.

When the gas is injected through the drilled holes and apertures, exposure of the ground meat to the gases will be maximized. The ground meat can be shaped or profiled and cut into portions of specified size and directly loaded into packaging while enclosed in a space containing the gas.

Temperature of the gas or blend of gases can be controlled, and may include individual gases in varying relative proportions so as to optimize the cooling of the meat simultaneously while providing sufficient carbon dioxide to allow maximized dissolving of carbon dioxide into the water contained in the freshly ground meat content liquids.

Gases will be injected into the grinding head at a pressure that will purge or cause to be expelled, substantially all atmospheric gases from the grinding head and both upstream and downstream of the grinding head. Covers (not shown) will enclose the portions of the grinding process, package filling and packaging equipment to limit and control escape of dangerous levels or quantities of carbon dioxide or other gases that may cause damage to health of any machine operators and/or personnel. Gas extraction fans can be located adjacent to the equipment to ensure that safety to operators of the equipment is maintained.

Covers will also restrict egress of atmospheric gases, such as oxygen, from contacting the freshly ground beef and/or meat prior to packaging and hermetic heat sealing of each package. Such apparatus will substantially inhibit the oxidation of deoxymyoglobin contained in those freshly ground meat portions that were previously not exposed to atmospheric oxygen.

Alternatively, a suitably concentrated solution of carbonic acid can be injected into the grinding head 1300 at port 1322, or mixed with the meat portions immediately prior to grinding such that it becomes mixed with the meat in the grinding process. Subsequent to grinding, the ground meat can be carried through a tube or “tunnel” that is filled with carbon dioxide.

Alternatively, prior to grinding the meat, the portions of meat are passed through a carbon dioxide tunnel to evaporate a quantity of free water equal to the amount of carbonic acid injected into the grinding head. Carbonic acid solution may be sprayed onto the portions of meat while passing through the carbon dioxide tunnel. Solid carbon dioxide (“snow”) may be dissolved into water to produce carbon dioxide solution (carbonic acid and water). A measured quantity of snow may be injected into the grinding head at a point immediately adjacent but located on the up stream side of the grinding head such that, during the grinding process, the solid carbon dioxide is blended with the meat so as to substantially cover the surface of the meat particles after grinding. A controlled and continuous weighing and feeder device may be used to accurately dispense the solid carbon dioxide.

The process of the present invention advantageously inhibits the growth of bacteria on the surface of the meat portions and particles and maximizes shelf life of the meat for a longer period than the shelf life period that would otherwise be possible without an increase of dissolved carbon dioxide in surface water and also minimizes exposure of ground meat to atmospheric oxygen while in processing from grinder to retail pack. This reduces the normal event of the oxidation of deoxymyoglobin, contained in the meat prior to cutting, to oxymyoglobin and then the reduction back to deoxymyoglobin after packaging in the packages that do not contain oxygen. Alternatively, freshly ground or cut meat may be passed through apparatus for removing and collecting some of the free surface liquid in a continuous or batch process such as with a centrifuge. The liquid is then processed by way of pasteurization at a temperature that does not cause any undesired effects on the ultimate oxidation of the deoxymyoglobin to oxymyoglobin to produce a desirable fresh red color at the point of sale. The liquid can also be exposed to carbon dioxide by mixing with solid or gaseous carbon dioxide. After sufficient carbon dioxide has dissolved into the liquid, the liquid can be sprayed onto meat or other types of goods in a continuous production process.

Alternatively, in another embodiment of the present invention, the carbonation of the free surface liquid may be achieved by including a further step in the process/method of producing modified atmosphere retail packages. Fresh meat can be packaged in a substantially gas impermeable plastic package including a thermoformed tray and flexible plastic lid, hermetically sealed to the tray. The process involves locating the tray (with fresh meat) in an enclosed chamber and then substantially removing atmospheric air from within the chamber before filling the chamber with a blend of desired gases followed by hermetically sealing the lid to the tray. The present invention provides an apparatus and method for, after substantially evacuating the chamber and filling the chamber with the desired gas, compressing the gas (blend of N₂ and CO₂ or 100% CO₂) within the chamber to an optimized pressure of between slightly above ambient atmospheric pressure and up to 6 bar (6 times the atmospheric pressure). The gas pressure within the chamber is then lowered to ambient pressure (1 atmosphere) and the package is then hermetically sealed. This process of carbonation increases the quantity of carbon dioxide that is dissolved into the liquid in the meat and goods. After hermetic sealing of the package, the liquid is substantially saturated with dissolved CO₂. This inhibits further dissolving of CO₂ into the liquid, that may otherwise cause the package to collapse, and can also extend the shelf/storage life of the meat when held under refrigeration (at between about −2 to about 4 degrees C.).

Referring now to FIG. 9, another pressure vessel assembly constructed according to the present invention is shown. The pressure vessel 1600 saturates any given quantity of ground meat, with absorbed or dissolved gases and particularly carbon dioxide gas while also controlling the temperature of the ground meat and minimizing or eliminating freezing of the ground meat during the process.

An adapter tube 1602 is shown connecting a meat grinder 1604 to the pressure vessel assembly 1600 and is provided with an airtight connection. Compacted meat 1606 is shown within the meat grinder 1604. The compacted meat 1606 is forced through holes in a plate and cut by a rotating blade in a manner as is typically incorporated in most meat grinders and is well known to manufacturers and users of meat grinding equipment. Compacted meat provides a seal to substantially prevent escape of pressurized gases that may be provided to the pressure vessel. A port 1608 is provided in a section of the meat grinder 1604 to allow injection of gases such as carbon dioxide or blends of carbon dioxide, nitrogen or any other suitable gas. Injection of the gases into port 1608 substantially purges air that is in contact with the meat just prior to grinding and displaces the air with the desired gas. The gases may include a gas blend of carbon dioxide and nitrogen where the percentage of carbon dioxide is about 95% and the balance of about 5% includes nitrogen. The interior of pressure vessel 1600 is substantially isolated from atmospheric air and is fitted with a removable dome 1610. Removable dome 1610 can facilitate easy access for general cleaning and sanitizing purposes. The main portion of pressure vessel 1600 is enclosed by a jacket 1612 providing a space between the jacket 1612 and walls of pressure vessel 1600. Temperature is controlled by circulating fluid through jacket through port 1614 and extracted through port 1616. A cross-section of the vessel 1600 through the jacket and pressure vessel walls is shown in FIG. 10 for clarity.

A port 1622 is provided at the apex of removable dome 1610 providing a port to inject gases and other substances such as O₃, F₂, H₂O₂, KMnO₄, HClO, ClO₂, O₂, Br₂, I₂, or any combination thereof and flavors into or alternatively extract from within the pressure vessel through port 1622. Alternatively, a gas blend is injected into the pressure vessel through port 1622 and maintained at a pressure of about 25 psi. A gas blend including nitrogen and/or carbon dioxide and/or ozone (O₃) will be provided into pressure vessel via port 1622. Water and oils contained in the ground meat can then absorb carbon dioxide until it becomes substantially saturated and cannot absorb any additional carbon dioxide. A controller to maintain and/or adjust and vary pressure of the gases within the pressure vessel, as desired, is also provided but not shown. A side port 1624 is provided in the wall of the pressure vessel through which ground beef may be provided into the pressure vessel 1608 for further processing in the pressure vessel assembly. The size of the pressure vessel can be adjusted to suit requirements. The dimensions of length and height may be increased or decreased to accommodate the required processing capacity of the first pressure vessel assembly. The lower end of the pressure vessel 1600 is attached to a horizontally displaced tube section 1626 within which an auger 1628 is mounted. Auger 1628 includes passageways and holes 1646 provided so as to allow injection of gases therethrough by connection to a source of gases through port 1648, thus substantially maximizing exposure of the ground meats to direct contact with the gas blend. Tube section 1634 has a length dimension which can be increased or decreased according to requirements. Auger 1628 is attached to a driver (not shown) that can provide a force to rotate auger 1678 in a direction such that ground meat will be transferred through horizontally displaced tube section 1626 and toward a tapered tube section 1632. Driver has the capacity of rotating auger 1628 at a desirable speed which can be adjusted as may be required to optimize throughput of ground meat by first pressure vessel assembly.

Fine ground meat passes into the pressure vessel 1600 and accumulates until the upper level of accumulated ground meat is adjacent to proximity switch 1650. Switch 1650 sends a signal to the variable speed drive motor which starts to slowly rotate auger 1628. Ground meat continues to accumulate and when level reaches a point adjacent to proximity switch 1652 variable drive motor is accelerated to a higher speed. The level of ground meat may continue to elevate and when the level reaches proximity switch 1652 drive motor speed is increased to maximum speed causing the level of ground meat to drop below a level adjacent to 1654 at which point the drive motor slows down to a lower speed. When the level of ground meat drops to a level below 1650 the drive motor is signaled to stop. Therefore, in this fashion, the level of ground meat within the pressure vessel 1600 can be maintained at a point between the lowest proximity switch 1650 and the highest proximity switch 1652.

Tapered tube section 1632 has ports 1634 and 1636 to allow injection of gases into section 1632 or allow gases to be extracted from within the tapered section. Additional ports may be provided through any part of apparatus walls as may be required to optimize efficiency and operation of pressure vessel assembly. A transfer section 1630 is located at the egress end of tapered tube section 1632. Section 1630 is provided with a port through which gases may be injected into or extracted from within section 1630. A desired profile can be varied by interchanging an extruded profile section 1640. The continuous length of extruded food product can be severed by a cutting device such that pieces of extruded food can be provided with specified and desired lengths. The pieces of extruded food can then be packaged into packages of suitable size. Such an extruded profile section 1640 is attached to the egress end of the transfer section 1630. A cross-section through section 1640 is shown in FIG. 11 where a rectangular profile can be seen. Ground meat can be compressed by auger 1628 and thereby forced through section 1640. Compression of the ground meat through the profiled section provides a similar rectangular profile to the ground beef as it passes through the egress end of section 1640.

A side view and end view of an alternative extruded profile section 1640 in the form of a manifold is shown in FIGS. 12 and 13. Manifold 1642 includes a series of three tube profiles through which ground meat can be extruded. Such a process can provide three separate streams of profiled ground meat. The manifold 1642 may include one or several streams of profiled ground meat. A tube of similar internal cross-section to the stream of ground meat may be connected to each stream of ground meat and thereby contain each stream of ground meat separately within a corresponding number of tubes so as to allow transfer of the profiled ground meat to other processing equipment such as automatic ground meat patty production equipment or a second pressure vessel. The tube(s) will thereby provide protection to the ground meat and substantially isolate it from contact with external contaminants or atmosphere.

A three-way valve (not shown) can be inserted between transfer section 1630 and profile section 1640. The three-way valve can be attached to section 1630 and section 1640 in a substantially airtight fashion so as to provide direct connection to each other or a connection to an alternative tube connected to other equipment or to port 1624. This provides diverting the ground meat to other equipment for further processing or, as may be required at the start of a period of production, diversion of the ground meat into a first pressure vessel through port 1624 for additional processing to ensure that the ground meat is substantially saturated with dissolved carbon dioxide or other gases. After the ground meat has been re-processed, which may require return to pressure vessel 1600 via port 1624 repeatedly, the three way valve can be switched to direct passage of the ground meat through the extruded profile section 1640 or other equipment for further processing or retail packaging. Automated valves to close all ports shown and any others that may be provided, in a substantially airtight manner, are provided to each port, but not shown.

As can be learned and understood with the foregoing description an adequately effective gas tight seal can be provided by compacted meat 1606 within meat grinder 1604. Furthermore, auger 1628 can be arranged so as to fit closely within transfer sections 1632 and 1630 such that when 1628 is rotating, during normal operation of the apparatus, ground meat will become compacted within 1632 and 1634 and around auger 1628 and thereby provide an adequately effective gas tight seal. Therefore, gas pressure within the pressure vessel 1600 can be increased to above ambient atmospheric air pressure as required and maintained at a selected pressure by a controller to maintain and/or adjust and vary pressure of gases within the pressure vessel 1600, as desired. The gases within the pressure vessel 1600 will therefore be substantially contained between the compacted meat at 1606 in the meat grinder and compacted meat 1656, within transfer sections 1632 and 1630 at a desired pressure. Pressure can therefore be maintained at a pressure most suited for rapid absorption by water and oils in the ground meat contained within the apparatus during operation and transfer of the ground meat through the apparatus.

A second and additional pressure vessel assembly of similar construction to the first pressure vessel assembly, can be provided and attached to the first pressure vessel assembly via an adapter tube so as to provide direct passage of the ground meat from the egress point at the extruded profile section 1640 by way of a tube connected directly to the adapter tube 1602 into the second pressure vessel assembly thereby providing direct communication to the second pressure vessel. After passage of the ground meat through the first pressure vessel it can therefore be passed directly into a second pressure vessel. The second pressure vessel is attached to a vacuum pump via a similar port to that as shown as port 1622 in FIG. 9. The port shown as port 1624 is not provided in the second pressure vessel. A suitable gas such as nitrogen is injected into ports provided in the second pressure vessel assembly which are shown as ports 1608, 1634 and 1636 and the nitrogen gas is also injected through ports and passageways in auger, also provided in the second pressure vessel assembly and shown as 1628 in the first pressure vessel assembly. The gas pressure within the second pressure vessel assembly is maintained at approximately a pressure equal to or higher to the prevailing atmospheric pressure. The ground meat is passed through the second pressure vessel assembly and through extruded profile section and into other equipment as required for packaging and or further processing. Passage of the ground beef through the second pressure vessel assembly removes free carbon dioxide that may remain within the voids contained within the ground meat and replaces it with a gas such as nitrogen.

One embodiment provides a method of substantially restricting the escape of any gases, such as carbon dioxide or ozone, from an apparatus, that may be hazardous to the wellbeing of operators of the apparatus. This can be achieved by locating the apparatus, such as shown in FIG. 9, within a confined space such as an enclosed room or other enclosure that is substantially filled with an inert gas such as nitrogen. The enclosure may include several parts and be arranged to cover only certain parts of the apparatus. The apparatus can be arranged such that certain parts are exposed to allow access or loading. The gas contained in the room or enclosure will be substantially nitrogen with a residual oxygen content of less than 20,000 parts per million. The enclosures or room can be extended to enclose or house other equipment such as conveyors and packaging apparatus that may be used to process and package the ground meat. Such an arrangement would isolate the ground beef from contact with gases containing oxygen in concentrations greater that 20,000 parts per million, or greater than 300 parts per million, and allowing the ground meat, which may be ground beef, to be packaged in a vacuum pack or a modified atmosphere package containing a gas that includes a blend of desired gases but containing residual oxygen of not more than 500 parts per million. The gas contained within the enclosures or the room may be pressurized and vented to a convenient and safe point into the atmosphere.

In another embodiment, a series of enclosed vessels which may be pressure vessels, can be connected together, in series, via suitable conduit means with a positive displacement pump located between each pressure vessel and connected to the conduit means such that a pump can transfer product such as ground meat, by pumping means, from a first pressure vessel to a second pressure vessel. Goods such as ground meat can be transferred directly from a grinder into a first pressure vessel and a first pump can transfer the ground meat from the first pressure vessel to a second pressure vessel. A second pump can be provided to transfer the ground meat from the second pressure vessel to a third vessel and a third pump can be provided to transfer the ground meat from the third vessel to a fourth vessel. Any desired number of vessels and pumps may be assembled in series so as to provide a method of transferring the ground meat progressively from the first vessel to subsequent vessels as may be required. Gases and/or other goods and materials may be transferred by any suitable means into any of the vessels at any suitable temperature and pressure. Blending and mixing devices may be installed in the vessels, as may be required, and any suitable means of controlling and adjusting temperature of goods transferred into and from the vessels can be provided. In this way, each vessel can be separately and independently controlled and arranged with a holding capacity to accommodate any desired quantity of ground meat, with selected gases and other materials provided therein, and held at any chosen temperature and pressure. Each pump can be arranged to separate each vessel such that temperature and pressure can be independently adjusted in each of the vessels.

In this way, ground meat (and other meats) can be processed so as to substantially prevent the formation of oxymyoglobin immediately after grinding. The ground meat can then be retail packaged in a low oxygen package such as a master package system as described herein and delivered to the point of sale in a de-oxymyoglobin condition. The package can be removed from the de-oxymyoglobin condition immediately prior to retail display so as to allow generation of the consumer appealing red color or “bloom” for the first time after grinding.

Referring now to FIG. 14, a meat grinding assembly constructed according to the present invention includes a first and second meat grinder that are in direct communication via a pressure vessel 1700. First meat grinder 1702 is fitted with an auger 1704 and meat grinder 1702 is attached to pressure vessel 1700 via adapter tube 1706 thereby providing direct communication to transfer ground meat that has been ground by grinder 1702 directly into the pressure vessel 1700. Adapter tube 1706 is provided with a substantially gas tight seal at the point of connection to pressure vessel 1700 such that pressurized gas that can be provided into vessel 1700 will not escape. The adapter tube 1706 is fitted with a valve (not shown), such that when grinder 1702 has completed grinding and no compacted meat remains in the grinder, the valve can be closed thereby closing communication between the pressure vessel 1700 and grinder 1702. Closing the valve can thereby allow continued processing of any coarse ground meat that may remain in pressure vessel 1700 with gas provided therein under pressure and above ambient atmospheric pressure as required and until all coarse ground meat contained in the pressure vessel 1700 has been processed through second fine meat grinder 1738 and into downstream pressure vessel 1730. Furthermore, if so desired an additional valve, similar to the valve at grinder 1702, can be provided in the adapter tube 1718 so as to allow further processing of the fine grinds in the pressure vessel 1730.

Pressure vessel 1700 is fitted with a removable dome 1708 in which is provided a port 1710. The lower portion of pressure vessel 1700 is attached to a housing containing auger 1712 which is directly attached to a variable speed drive (not shown) that can rotate auger 1712 in a direction that causes coarse ground meat to be urged into and through blade 1714 and plate 1716. An adapter tube 1718 is fitted so as to provide direct communication to pressure vessel 1730. Proximity switches 1720, 1722 and 1724 are conveniently located in walls of the pressure vessel 1724. Proximity switch 1720 is located at a point higher than the location of switch 1724, and switch 1722 is located between switches 1720 and 1724.

Pieces of meat are placed into a hopper (not shown) attached to first meat grinder 1702 and auger 1712 is rotated to cause pieces of meat to be urged through a rotating blade 1736 and a perforated plate 1734. Compacted meat 1726 accumulates in a compressed condition just prior to passing through blade 1714 and plate 1716, providing a gas tight seal between the grinder 1702 and the pressure vessel 1700. Coarse ground meat passes into pressure vessel 1700 and accumulates until the upper level of accumulated ground meat is adjacent to proximity switch 1724. Switch 1724 sends a signal to a variable speed drive motor (not shown) connected to shaft 1728 which starts motor to slowly rotate auger 1712. Coarse ground meat continues to accumulate and when level reaches a point adjacent to proximity switch 1722, the variable drive motor is accelerated to a higher speed. The level of ground meat may continue to elevate and when the level reaches proximity switch 1720, the drive motor speed is increased to maximum speed causing the level of ground meat to drop below a level adjacent to switch 1722 at which point the drive motor slows down to a lower speed. When the level of ground meat drops to a level adjacent to switch 1724, the drive motor is signaled to stop. Therefore, in this fashion, the level of ground meat within the pressure vessel 1700 can be maintained at a point between the lowest proximity switch 1724 and the highest proximity switch 1720. Meat is compacted just prior to passing through rotating blade 1714 and perforated plate 1716, thereby providing a gas tight seal between pressure vessel 1700 and pressure vessel 1730.

In this fashion, compacted meat remains in a compacted condition at location 1732 and 1726 providing gas tight seals. A desired gas or blend of gases can be injected into pressure vessel 1700 at a desired pressure. Gas pressure is slightly above ambient atmospheric pressure or up to 150 psi and is maintained at desired pressure by metering and gas pressure regulating equipment (not shown). In this fashion gas can be continuously injected into the pressure vessel 1700 and maintained at a desired pressure at a rate equal to the rate of absorption of gases by the ground meat. The meat and ground meat may be compacted to provide substantially gas tight seals as described herein while providing for a continuous production process of meat treatment during the meat grinding procedure. Production speed can be adjusted to optimize the gas absorption (and contact with surface of the ground meat) at a desired rate while maximizing output of the apparatus and equipment.

In yet another embodiment, pressure vessel 1700 and/or other pressure vessels attached thereto are provided with valves, that can be opened and closed, and that are provided at all ports, adapter tubes, entry and egress apertures in the pressure vessel(s), so as to enable isolation of the pressure vessel(s) from external ambient atmosphere. When isolated, gas pressure within the pressure vessel(s) may be adjusted to a suitable and adjustable pressure below and/or above ambient atmospheric pressure. The gas pressure, in the pressure vessel, may be increased and decreased in a pulsating and/or oscillating frequency and pattern that can provide for the efficient removal of undesirable gases and the replacement with desirable gases at a desired pressure.

A processing system is disclosed including a meat grinder and a processing and blending tube with three augers to transfer the meat through the system. The tube includes a heat exchanger to maintain temperature and ports for the introduction of conditioning gases.

FIGS. 15-18 disclose an apparatus constructed according to the present invention arranged to process perishable foods such as ground beef. The apparatus can be assembled in a gas tight manner with components manufactured from any suitable materials such as approved stainless steel or plastics. The assembled apparatus may be arranged in a horizontal disposition or with devices to adjust the horizontal disposition to any desirable angle of repose.

Apparatus 5600 includes an enclosed vessel 5624 of circular cross-section profile, with end enclosures 5602 and 5604. Vessel 5624 can be arranged to contain any suitable gas at any suitable internal gas pressure and at any suitable temperature. The temperature of the gas is controlled. Vessel 5624 can be fitted with drivers 5614, 5616, 5618 and 5620 attached thereto at suitable convenient locations and as required to provide driving forces to a round blending tube, shown as 5622, located inside vessel 5624. The drivers can be controlled to drive the tube 5622 at a suitable constant and variable speed. The tube 5622 engages with four drive wheels, all shown as 5626 for clarity, and tube 5622 is supported thereon, but otherwise is free from contact with other components except for suitable contact with seals as may be required at each end of the tube 5622. Drive wheels 5626, are engaged to the corresponding drivers. In this way, the tube 5622 is retained by the drive wheels, 5626, in a horizontally disposed position or as may be otherwise required. Pressure vessel 5624 is fitted with vent 5628 which can be provided with a valve (not shown) to allow any excess liquids or gases to be drained therefrom. A vent with valve and venturi, 5632, can be fitted to vessel 5624. Any desired number of vents with valves and venturis can be fitted to the vessel 5624. Venturis can be arranged to provide gas injection into space 5636 in such a manner that will cause the injected gas to flow along space 5636 and then through tube 5622, in a desired direction at a suitable velocity.

The tube 5622 is arranged inside the vessel 5624 and passageway is thereby provided between the outer surface of the tube 5622 and the inner surface of vessel 5624. Gas can therefore be provided inside the pressure vessel and in the passageway. Any suitable gas temperature controller may be arranged such as by arranging a heat exchanger 5638 connected to the vessel 5624 as shown. A first and second suitably sized tube, 5640 and 5642 are attached in direct communication with vessel 5624 such that gas can pass between the tubes and the vessel 5624. Tube 5640 is connected to the heat exchanger 5638 and another connecting tube 5644 is attached to a gas blower 5646 which in turn is connected to the connecting tube 5642. In this way gas can pass through tube 5640, into and through the heat exchanger 5638, through tube 5644, into and through the gas blower 5646, and through connecting tube 5642. A barrier 5648 is located in space 5636 which can follow the outer circumference of tube 5622 so as to substantially inhibit gas passing therethrough. In this way, when gas blower 5646 is activated, gas can be drawn in from space 5636 on one side of barrier 5648, through tube 5640 and passed through tube 5642 and back into space 5636 on the opposite side of the barrier 5648. This provides recirculation of any suitable gas along the space 5636, through tube 5622, back into space 5636 and again through the heat exchanger 5638. The gas can be re-circulated and repeatedly passed through heat exchanger, 5638, to maintain the gas at a desired temperature. A tube shown as 5650 is provided to allow suitable gas to be injected into the heat exchanger 5638. The suitable gas can be provided in a liquid or high pressure condition and allowed to expand in the heat exchanger 5638, and thereby cause a lowering of temperature. Suitable gas can then pass from heat exchanger 5638 and into tube shown as 5652 which is connected to tube 5644. Alternatively, suitable gas can be allowed to escape through tube 5654 and valve 5656. In this way, by controlling the flow of gas, the internal temperature of vessel 5624 and all other items therein can be controlled. During the re-circulation of gas through tube 5622 and heat exchanger 5638, a quantity of water, contained in the grinds, may evaporate and condense in heat exchanger 5638. The quantity of condensed water in the heat exchanger may be processed, sterilized and carbonized, by dissolving carbon dioxide therein and then injected into the grinds through vent tube 5658. Tubes 5652 may be provided with pressure regulators and valves to allow excess gas to escape therethrough, from vessel 5624 at a suitable rate and in such a manner as to maintain the temperature of the gas within a temperature range of plus or minus about 0.5 degrees F., or at any other suitable temperature range. The suitable gas and/or any other suitable substances can be provided in vessel 5624 at any suitable gas pressure to facilitate dissolving of the gas and/or substances into the ground meats contained in the tube 5622. In this way, the suitable gas can be controlled to either chill or heat the ground meats being processed in tube 5622, and by the apparatus.

End enclosure 5602 has a plurality of apertures. Cover 5660 is located over an inspection access hole so as to provide a convenient access into the apparatus for any purpose such as for cleaning. A vent 5662 is provided to allow excess gas to escape. Vent 5662 can be attached to suitable valves with gas pressure regulators as may be required to control gas pressure. A tube 5664 is located through a tube in the wall of end enclosure 5602. Tube 5664 connects to a nozzle that can be arranged to provide temperature controlled water or other liquids, at any suitable pressure into the inner space contained within tube 5622. The water or other liquids can be used to clean the internal surfaces of the apparatus after use of the apparatus. Bearings such as bearing shown as 5668 are also located in the end enclosure 5602.

End enclosure 5604 includes several openings with other apparatus attached thereto. Three variable speed drive motors, 5614, 5618 (one not shown) are fixed to the end enclosure 5604 and each motor is attached to a corresponding shaft shown as 5676 and 5680 (one not shown). A subassembly 5601 is mounted to end enclosure 5604 in a desired position and can pass ground beef into the tube 5622 directly from a grinding apparatus without contacting atmospheric air. All shafts, tubes, components and assemblies attached to end enclosures are sealed in a suitable and desired gas tight manner, thereby retaining any gas that may be contained within vessel 5624, at any suitable pressure.

Three separate augers (two shown), depicted as 5676 and 5680 are mounted in close proximity to each other and with a member 5682 arranged above auger 5676 separating it from augers 5678 and 5680. Augers 5676, 5678 and 5680 can be arranged in a horizontally disposed and parallel position. Auger 5676 is attached to drive motor 5614, auger 5678 is attached to drive motor 5616 and auger 5680 is attached to drive motor 5618. The end sections of each auger 5676, 5678 and 5674 are arranged with shafts and each shaft end mates with bearings located in end enclosures 5602 and 5604. Drive motors 5614, 5616 and 5618 are arranged to drive the corresponding augers at variable rotating speeds in any chosen direction, either clockwise or counterclockwise, as may be selected according to any desired direction and at any suitable speed that will enable optimized mixing of the ground meats processed in tube 5622. Alternatively one or any number of augers may be located in tube 5622 to provide the most optimized mixing therein.

Sub-assembly 5601 is attached to end enclosure 5604 and can be operated to grind beef and inject the ground beef directly into tube 5622. In this way, ground meat can be continuously provided into tube 5622, at any suitable rate within the capacity of the apparatus. Referring to FIG. 18, the ground beef that flows into tube 5622 can be arranged to fall directly onto but centrally and between the center lines of augers 5678 and 5680. Augers 5678 and 5680 can be arranged to rotate in opposite directions. Direction of rotation of auger 5680 can be in a clock-wise direction and auger 5678 can be rotated in a counter clockwise direction. In this way, the ground beef can be carried by augers 5678 and 5680 toward end enclosure 5602 and away from end enclosure 5604. Member 5682 is arranged to allow containment of the ground beef between its upper faces and augers 5678 and 5680 for a brief period such that as augers rotate, the ground beef is carried toward the end enclosure 5604. As augers 5678 and 5680 rotate, the ground beef will then drop and contact tube 5622. Tube 5622 can be arranged to rotate at a suitable speed, of between about 100 rpm or less and about 500 rpm or more, such that centrifugal force will hold the ground beef against the internal surface of tube 5622. When tube 5622 has rotated by approximately one half of one revolution and the ground beef is carried to an upper location and above augers 5678 and 5680, a scraper 5625 can be provided to remove the ground beef from contact with tube 5622. The scraper 5625 can be arranged to cause the ground beef to be directed back onto augers 5678 and 5680. Auger 5676 can be driven in a direction that will carry any ground beef that it contacts, toward the end enclosure 5604. The rotating speed of each auger can be adjusted as required. Auger 5676 can be arranged to have an extended length that is longer than augers 5678 and 5680 such that 5676 extension extends beyond augers 5678 and 5680 and into a tubular section, shown as 5722, with an internal diameter slightly larger than the external diameter of auger 5676. As shown in FIG. 15, auger 5676 can then be arranged to carry ground beef from within tube 5622 and through tubular section 5642 at a desired rate. In this way the ground beef will be carried toward end 5604 by augers 5678 and 5680 and toward end 5602 by auger 5676. The rotation of tube 5622 and its interaction with the scraper 5625 will then provide further mixing of fat and muscle content of the ground beef. By independently adjusting the rotating speed of augers 5676, 5678 and 5680 and also tube 5622, the period of time that the ground beef is retained within the tube 5622 can be controlled to an optimized period of time and thereby allow an efficient method of blending. After a suitable period of retention, the ground beef will be transferred through tube 5642 and will then fall downwardly into tube 5724. Tube 5724 can be located directly above and connected to a suitable vane pump shown as 5726, which may include any suitable vane pump manufactured by Weiler & Company, Inc. The ground beef can be pumped at a known and controlled velocity by vane pump 5726 into tube 5728 which is connected directly thereto. Tube 5728 can be connected to measuring device 5730. In this way, ground beef can be ground and injected into tube 5622 by sub-assembly 5601, and after passing through a first measuring device blended by augers before pumping through a second measuring device 5730 located between tubes shown as 5728 and 5732. Ground beef can be conditioned and blended at a production rate limited only by the chosen size and capacity of the ground beef conditioning and blending apparatus, which may be varied in size and capacity as required.

The conditioned and blended ground beef can thus be pumped through tube 5732 at a desired and controlled temperature with a quantity of suitable gas such as carbon dioxide, dissolved in the ground beef to any desired level of saturation. Vane pump 5726 can be provided with a variable speed drive motor and arranged to pump ground beef at a controlled velocity into other apparatus for subsequent blending with other ground beef or chosen material and/or further processing.

In one embodiment, the conditioned ground beef may be exposed to a suitable beam of electrons by locating an electron beam generator and accelerator such as may be manufactured by Titan-Scan Systems of 3033 Science Park Road, San Diego, Calif. 92121. The electron beam generator may be located in such a manner that the suitable beam of electrons produced there with, is directed directly at and through a stream of grinds while the grinds are passing through a tube such as tube 5754 shown in FIG. 19. The cross-sectional profile of the tube may be arranged to provide maximum exposure to the electron beam. In this way the conditioned ground beef can be sterilized at any temperature while maintaining a fresh and uncooked condition. Electron beam sterilization is used on fresh ground beef which is in a low oxygen environment to prevent over-oxidation. In an alternative embodiment, the stream of conditioned ground beef can be exposed to irradiation from a source of gamma rays.

Referring again to FIG. 19, a section of assembled tubes is detailed. The section of tubes includes a first tube 5744, a second tube 5746 and a third tube 5748 which are all joined at a confluence, 5750, to a fourth tube 5754. The tubes and particularly the confluence may be manufactured from any suitable plastics or stainless steel materials and machined so as to ensure that any processed materials passing therethrough, will not be subject to significant turbulence until after passing through the confluence 5750. Any number of two or more tubes joined, at a confluence, to a single tube 5754, may be arranged to produce processed materials as may be desired. In one embodiment, a first processing machine (not shown), is arranged to deliver the processed material via tube 5744, a second processing machine (not shown), is arranged to deliver the processed material via tube 5746 and a third processing machine (not shown) is arranged to deliver the processed material via tube 5748. The fat content of each stream of ground beef can be measured, by any suitable measuring device such as that shown as 5730 in FIG. 17, and the fat content will therefore be known. The velocity of each stream of material can be adjusted by adjusting the speed of separate vane pumps arranged in such a manner so as to provide for velocity adjustment. By adjusting the velocity of each stream of processed material corresponding to the measured fat content contained therein, delivered quantities of the processed material, can be adjusted such that when any two or more streams are combined together, the resultant fat content of the combined stream will be substantially constant and as required. In this way, the known fat content of the combined stream of processed material can be maintained to within a narrow range of variation. The variation may be within a range of not more than +/−1% of the desired fat content of any stream.

Referring now to FIG. 20, one embodiment including a group of three blending tubes 5756, 5758 and 5760 is shown, each tube being similar in operation to tube 5622 shown in FIG. 15. The group of three blending tubes are each assembled with an auger similar to as described above in association with the tube 5622 and augers 5676, 5678 and 5680. Rollers 5762, 5764 and 5766 are arranged to engage and retain the blending tubes as shown. A pressure vessel 5768, is arranged to accommodate the group of three blending tube assemblies such that drive wheels 5770 are engaged there with and as shown and can be activated as required so as to rotate the blending tubes. Ground beef can be provided into each blending tube by similar apparatus to that disclosed above with sub-assemblies 5601 of FIG. 15. In this way, three grades of ground beef can be processed simultaneously in three continuous streams. Each of the continuous streams of conditioned ground beef can be further processed if desired.

In one embodiment, a plurality of processing machines are arranged to process material such as fine ground (or coarse ground) meat, such as beef grinds. Each of the processing machines may be similar to the apparatus shown in FIG. 15. A total of three processing machines can include a first machine, a second machine, and a third machine, and can be arranged so that each processing machine can process a separate quantity of boneless beef. The first machine may process a quantity of 90/10 lean to fat, the second machine may process a quantity of 75/25 lean to fat and the third machine may process a quantity of 65/35 lean to fat. The first, second and third machines will therefore produce first, second and third streams of ground beef of differing fat content (processed material) that, after processing, will be pumped, by separate vane pumps (for delivery as required), along tubes shown as 5732 in FIG. 15.

Any number of one or more processing machines may be arranged so to provide any number of streams of processed material. The streams of processed material may be combined and joined together in any chosen configuration, to produce one or more subsequent streams of processed material. The velocity of each stream of material may be adjusted, so as to deliver a known and corresponding quantity of processed materials with any desired fat content as required. The fat content and muscle content, of each stream of processed material can be continuously measured, as described herein, or in any other suitable manner. One or more streams of processed materials may be combined to produce a single stream of processed material. By adjusting the velocity and consequently the delivered quantity of each stream of material (before combining together into a resultant single stream) any quantity of any processed material, can be produced to a substantially constant and precise specification. The combined stream of processed materials may be further processed through a grinder and/or through processing machines such as that shown in FIG. 15. Additionally, the streams of processed materials may be directed through a tube that is exposed to sterilization such as by exposure to gamma irradiation, or any other suitable sterilizer while contained within the tube.

Subsequent to processing, the beef grinds or processed material can be retail or bulk packaged in any suitable manner, such as a substantially oxygen free modified atmosphere master package.

The packaging may be arranged to accommodate a variation in total volume of the package such as an expansion or contraction in volume. The package volume variation may occur as the temperature variation of the packaged processed material. The volume variation may correspond to the temperature variation as a result of any gases dissolved in the processed materials “boiling off” or again dissolving in direct relationship to the temperature variation. Accommodation of the variation in package volume may be achieved by provision of a suitably sized, flexible, substantially gas barrier package.

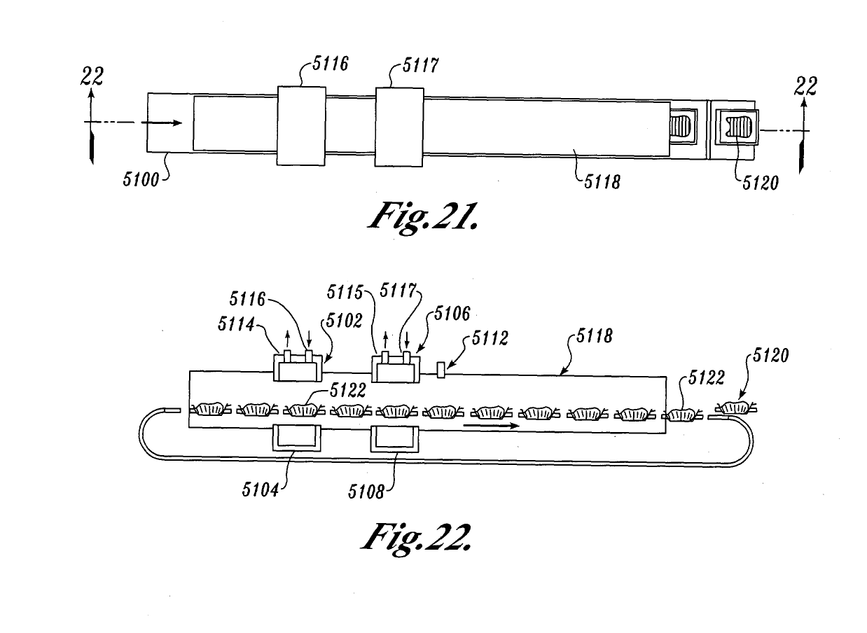

Referring now to FIGS. 21 and 22, a plan view and a side elevation view of an apparatus designed to slice meat while conditioning in an oxygen free environment is shown. The apparatus is shown in diagrammatic form and includes a continuous conveyor 5100, with a driver mounted to a rigid frame (not shown) and horizontally disposed to allow horizontal motion in a machine direction in intermittent or continuous movement. The conveyor is fitted with two corresponding and vertically opposed pairs of pressure chambers including an upper chamber 5102 with a corresponding lower chamber 5104 and another upper chamber 5106 with a corresponding lower chamber 5108. An enclosed gassing tunnel 5118 is arranged to enclose the upper section of the conveyor 5100 with a gassing port 5112 affixed thereto to provide any suitable gas, such as nitrogen gas or carbon dioxide, into the tunnel 5118.

Upper chamber 5102 and corresponding lower chamber 5104 are arranged to open and close. Upper chamber 5102 is mounted to a driver (not shown) to provide elevating, lowering and clamping of upper chamber. Lower chamber 5104 is also mounted to a separate driver (not shown) to provide elevating, lowering and clamping of lower chamber. Chambers 5102 and 5104 can be closed together by moving in opposing directions so as to contact each other along a path around the perimeter of chamber openings. In this way, a single chamber is so arranged in a manner that is airtight and sealed from external atmosphere. An evacuation port 5114 and a gas port 5116 are provided so as to allow evacuation and gas flushing of the closed chamber. As shown in FIG. 21 two separate pressure chamber assemblies are arranged such that conveyor 5100 passes through both chamber assemblies. Trays with sliced beef or other meat primal, placed therein, are located into carrier plates in conveyor 5100. The primals are sliced in a suitable manner and can then be opened so as to expose the multiple surfaces of the slices immediately prior to entry into enclosed tunnel 5118. Enclosed tunnel 5118 is arranged so as to substantially exclude atmospheric oxygen gas by flushing other suitable gases therein. The trays with sliced primal 5122 are located in carrier plates and progressively move through enclosed tunnel 5118 until each tray with primal is located directly between an upper chamber 5102 and lower chamber 5104. The upper and lower chambers close together and around the sliced primal 5122 in an airtight and sealed manner. Substantially all air is evacuated from the chambers and a suitable gas, including carbon dioxide, is injected through port 5116. The suitable gas pressure can be increased to any suitable pressure as desired. The primal 5122 can be retained in the pressure chambers for a desirable period of time so as to cause sufficient carbon dioxide gas to dissolve in the oils and water contained in the primal 5122. After the primal 5122 has been exposed to the high pressure carbon dioxide gas for a suitable period of time, the pressure chambers open and allow conveyor 5100 to carry sliced primal 5122 in tray, forward in machine direction and through the enclosed tunnel 5118. A second pressure chamber assembly may also be closed around the sliced primal 5122 in tray. Any suitable gas at any suitable pressure can be provided in the second enclosed chamber. Second chamber includes an evacuation port 5115 and a gassing port 5117. The sliced primal 5122 in tray is intermittently carried through the tunnel 5118 until it emerges at the exit end of the tunnel. In this way, rapid formation of oxymyoglobin is inhibited when the primal 5122 is exposed to ambient atmosphere.

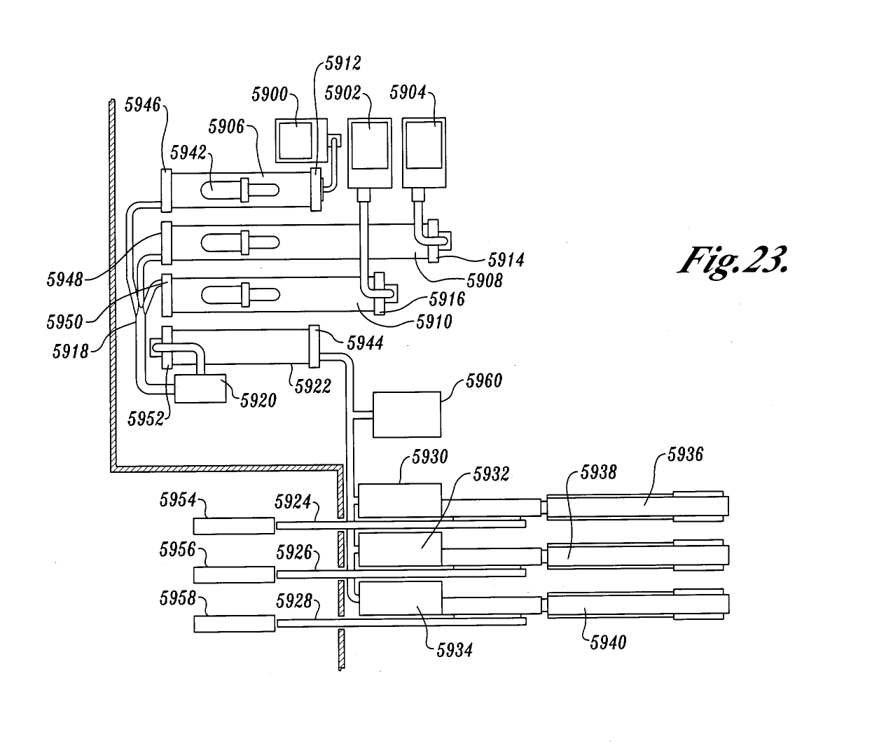

Referring now to FIG. 23, a plan view of one embodiment of a production plant layout is detailed including production and packaging equipment.

One embodiment includes items of equipment and identified by a reference numeral shown in Table 1 below.

TABLE 1

| | | | Packaging |
|---|---|---|---|
| Item # | Production Equipment | | equipment |
| 5900 | Grinding machine | 5960 | Chub/vacuum |
| | | | packaging machine |
| 5902 | Grinding machine | 5930, | Ground beef |
| | | 5932, | portioning machines |
| | | 5934 | |
| 5904 | Grinding machine | 5940, | Over wrapping |
| | | 5938, | packaging machines |
| | | 5936 | |
| 5906 | Ground beef processing machine | 5954, | Foam tray erecting |
| | | 5956, | machines |
| | | 5958 | |
| 5908 | Ground beef processing machine | 5924, | Conveyor belts |
| | | 5926, | |
| | | 5928 | |
| 5910 | Ground beef processing machine | | |
| 5922 | Ground beef processing machine | | |
| 5942 | Gas blower with heat exchanger. | | |
| 5912 | Ground beef Injector | | |
| 5914 | Ground beef Injector | | |
| 5916 | Ground beef Injector | | |
| 5944 | Ground beef Injector | | |
| 5946 | Vane pump | | |
| 5948 | Vane pump | | |
| 5950 | Vane pump | | |
| 5952 | Vane pump | | |
| 5918 | Multi-tube combining die | | |
| 5920 | Electron beam sterilizer and/or | | |
| | grinder | | |

The equipment shown in FIG. 23, and listed above, is arranged to continuously produce and retail package, case ready ground meats. Quantities of specified boneless beef raw materials are processed by grinding machines 5900, 5902, and 5904 to produce grinds that are transferred directly into ground beef processing machines 5906, 5908, and 5910 via corresponding injector machines 5912, 5914, and 5916. Each grinder processes a quantity of specified boneless beef raw materials, which may be selected from the following Table 2 of raw materials Item 1 through Item 5.

TABLE 2

| | Muscle | |
|---|---|---|
| Item | Tissue | Fat Tissue |
| 1 | 93% | 7% |
| 2 | 90% | 10% |
| 3 | 75% | 25% |
| 4 | 65% | 35% |
| 5 | 50% | 50% |

Equipment shown as vessels 5906, 5908, and 5910 is arranged to process grinds as the apparatus shown in FIG. 15. Grinds are injected into vessels from the grinders 5900, 5902, and 5904 by injectors 5912, 5914, and 5916 which are arranged to operate as the above-described apparatus shown in FIG. 15. Conditioned grinds are transferred in a single continuous stream from each vessel, by a pump from vessels into transfer tubes, which are then combined at confluence 5918 into a single tube. Confluence 5918 includes a manifold generally as the above-described apparatus shown in FIG. 19.

The fat content of the continuous streams of grinds is continuously measured by measuring devices as the above-described apparatus shown in FIG. 17. The fat content of the grinds can be continuously measured before injection into the vessels and immediately after transfer from the vessels and into the transfer tubes. By measuring the fat content and automatically adjusting the flow rate of each stream of grinds, directly and according to the measured fat content, prior to combining the streams of grinds, a combined stream of grinds with consistent fat content can be produced. The combined stream is then transferred via a tube into a single grinder shown as 5920. An electron beam generator of suitable capacity may be integrated such that the combined stream of grinds passes therethrough prior to injection directly into vessel 5922. Vessel 5922 may be arranged to process grinds as the above-described apparatus shown in FIG. 15. A single stream of conditioned grinds is then transferred into a single tube that is divided into four separate streams of grinds.

Still referring to FIG. 23, the plant layout includes four packaging systems and a single supply stream of grinds is transferred to each of the packaging systems. One stream can be provided to “chub/vacuum” packaging machine 5960. In one embodiment, apparatus constructed according to the present invention includes three packaging machines 5924, 5926, and 5928, and a single stream of grinds to each of three portioning machines, shown as 5930, 5932, and 5934, respectively. Portions of grinds are then retail packaged by automatic loading into trays which are then over wrapped by packaging machines shown as 5936, 5938, and 5940. While one embodiment has been described and shown to include three processing trains, any suitable number of processing trains may be used in accordance with the present invention, which may include more or less than the three trains herein described.

The equipment as described herein may be arranged to automatically produce any quantities of coarse or fine grinds according to any specifications. Equipment as described herein may be arranged to grind, measure, condition, blend, process, and package specified portions of grinds according to any suitable size automatically by a computer controller. The computer controller may continuously provide production information including such data as the total fat and muscle tissue content of each and all streams of grinds during the processing. In this way, a method to improve efficiency and reduce total losses is provided by producing grinds to meet precise specifications.

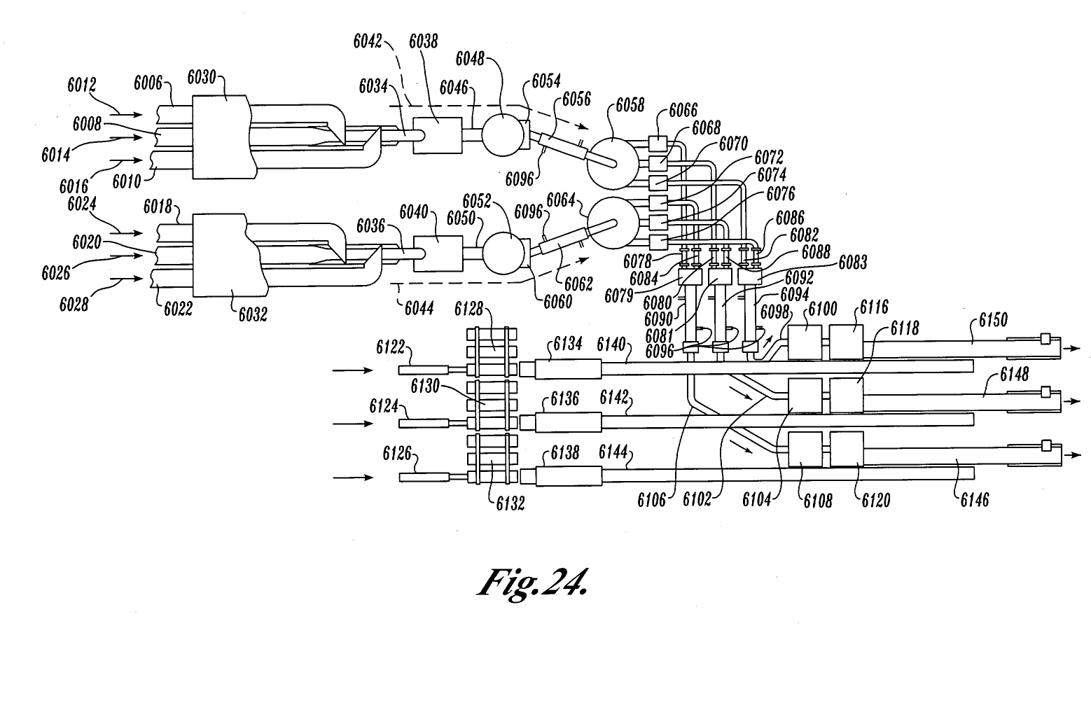

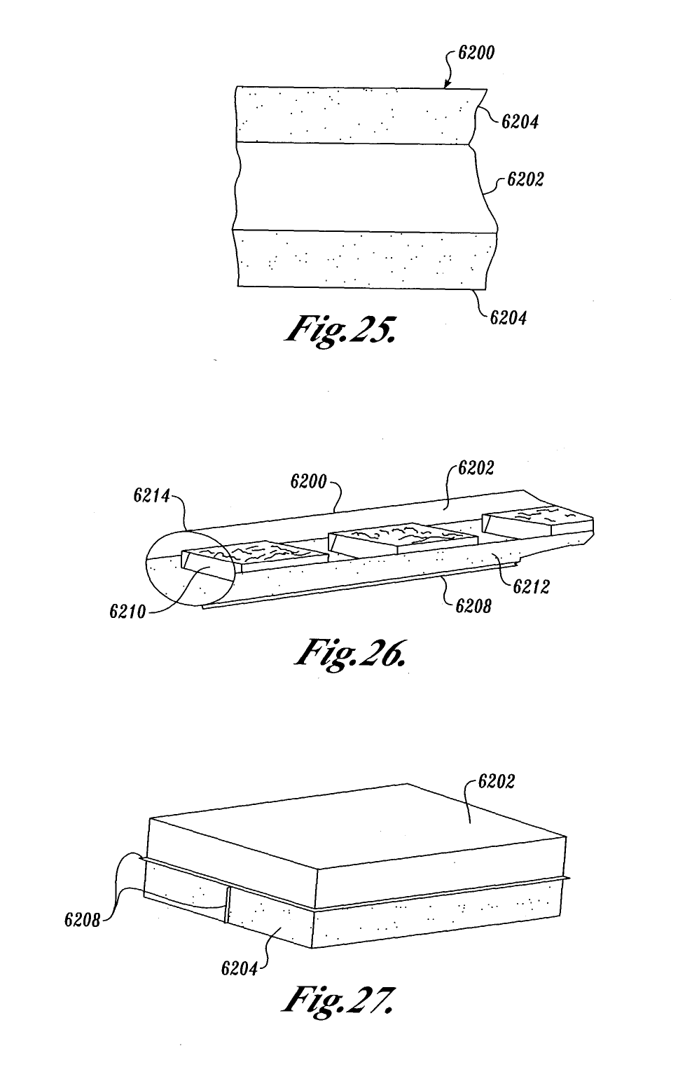

Referring now to FIG. 24, another embodiment of a production plant layout including ground meat processing and blending equipment and a CAP retail packaging plant layout including packaging equipment is shown. One embodiment of the present invention provides for a method of grinding meats directly into an oxygen free vessel or hopper and then blending and processing the ground meat as described herein. One embodiment of the present invention also provides a method of saturating the liquids, water, and oils in the ground meats with a suitable gas or substance, such as carbon dioxide, provided at a suitable pressure, to such a level that when removed from the processing equipment the ground meat will emit a suitable gas such as carbon dioxide.

Equipment shown in FIG. 24 is identified by numbers and listed in Table 3 below.

TABLE 3

| Item # | Production Equipment | | Packaging equipment |
|---|---|---|---|
| 6006 | Conveyor (with variable | 6122 | Magazine |
| | speed control) | | |
| 6008 | Conveyor (with variable | 6124 | Magazine |
| | speed control) | | |
| 6010 | Conveyor (with variable | 6126 | Magazine |
| | speed control) | | |
| 6018 | Conveyor (with variable | 6128 | Tray material evacuation & |
| | speed control) | | gassing |
| 6020 | Conveyor (with variable | 6130 | Tray material evacuation & |
| | speed control) | | gassing |
| 6022 | Conveyor (with variable | 6132 | Tray material evacuation & |
| | speed control) | | gassing |
| 6034 | Conveyor (with variable | 6134 | Tray flap erection & |
| | speed control) | | welding |
| 6036 | Conveyor (with variable | 6136 | Tray flap erection & |
| | speed control) | | welding |
| 6030 | Ultra violet sterilization | 6138 | Tray flap erection & |
| | equipment | | welding |
| 6032 | Ultra violet sterilization | 6140 | Conveyor |
| | equipment | | |
| 6038 | Grinding machine | 6142 | Conveyor |
| 6040 | Grinding machine | 6144 | Conveyor |
| 6100 | Grinding machine | 6116 | Ground beef portioning |
| | | | machine |
| 6104 | Grinding machine | 6118 | Ground beef portioning |
| | | | machine |
| 6108 | Grinding machine | 6120 | Ground beef portioning |
| | | | machine |
| 6046 | Tube connection | 6146 | Conveyor |
| 6050 | Tube connection | 6148 | Conveyor |
| 6048 | Ground beef hopper | 6150 | Conveyor |
| 6052 | Ground beef hopper | 6000 | Over wrapping packaging |
| | | | machines |
| 6058 | Ground beef hopper | 6002 | Over wrapping packaging |
| | | | machines |
| 6064 | Ground beef hopper | 6004 | Over wrapping packaging |
| | | | machines |
| 6056 | Statiflo blender | | |
| 6062 | Statiflo blender | | |
| 6090 | Statiflo blender | | |
| 6092 | Statiflo blender | | |
| 6094 | Statiflo blender | | |
| 6096 | Gas injection ports. | | |
| 6054 | Positive displacement pump | | |
| 6060 | Positive displacement pump | | |
| 6066 | Positive displacement pump | | |
| 6068 | Positive displacement pump | | |
| 6070 | Positive displacement pump | | |
| 6072 | Positive displacement pump | | |
| 6074 | Positive displacement pump | | |
| 6076 | Positive displacement pump | | |
| 6078 | Epsilon GMS-40 | | |
| 6084 | Epsilon GMS-40 | | |
| 6080 | Epsilon GMS-40 | | |
| 6086 | Epsilon GMS-40 | | |
| 6082 | Epsilon GMS-40 | | |
| 6088 | Epsilon GMS-40 | | |
| | Electron beam sterilizer | | |
| | and/or grinder | | |

The equipment shown in FIG. 24 is listed above and is arranged to automatically and continuously produce selected grades of retail packaged, case ready ground meats. The ground meats may include quantities of muscle and fat tissue such as shown in the following table, where item 1F includes ground meat with about 90% muscle tissue and about 10% fat tissue, with a muscle to fat tissue variation within about +/−0.2%. The packaging equipment shown in FIG. 24 can be arranged so that the packaging machine 6150 will produce CAP case ready packages containing ground meats according to a specification equivalent to item IF. Similarly, packaging machine 6148 can produce CAP case ready packages containing ground meats according to a specification equivalent to item 2F and packaging machine 6146 can produce CAP case ready packages containing ground meats according to a specification equivalent to item 3F in TABLE 4.

TABLE 4

| | Muscle | | |
|---|---|---|---|
| Item | Tissue | Fat Tissue | Muscle/Fat Tissue Variation |
| 1F | 90% | 10% | +/−0.2% muscle content |
| 2F | 85% | 15% | +/−0.2% muscle content |
| 3F | 80% | 20% | +/−0.2% muscle content |

Referring again to FIG. 24, variable speed conveyors 6006, 6008, and 6010 are arranged in close and parallel proximity such that each conveyor can carry specified quantities of selected boneless beef. In this way, conveyor 6006 can be arranged to carry specified quantities of raw material, which may be boneless beef selected from TABLE 5 shown below, in a direction indicated by arrow 6012, conveyor 6008 can be arranged to carry specified quantities of selected boneless beef in a direction indicated by arrow 6014 and conveyor 6010 can be arranged to carry specified quantities of selected boneless beef in a direction indicated by arrow 6016. The specified quantities of selected boneless beef can be varied between the conveyors marked 6006, 6008, and 6010 such that 6006 carries selected boneless beef shown as 2X, in TABLE 5, conveyor 6008 carries selected boneless beef shown as 3X and conveyor 6010 also carries the selected boneless beef shown as 3X.

Variable speed conveyors 6018, 6020, and 6022 are arranged in close and parallel proximity such that each conveyor can carry specified quantities of selected boneless beef. In this way conveyor 6018 can be arranged to carry specified quantities of raw material, which may be boneless beef selected from TABLE 5, in a direction indicated by arrow 6024, conveyor 6020 can be arranged to carry specified quantities of selected boneless beef in a direction indicated by arrow 6026 and conveyor 6022 can be arranged to carry specified quantities of selected boneless beef in a direction indicated by arrow 6028. The specified quantities of selected boneless beef can be varied between the conveyors marked 6018, 6020 and 6022 such that conveyor 6018 carries boneless beef shown as 1X in TABLE 5, conveyor 6020 carries boneless beef also shown as 1X and conveyor 6022 carries boneless beef shown as 2X.

TABLE 5

| Item | Muscle Tissue | Fat Tissue | Muscle/Fat Tissue Variation |
|---|---|---|---|
| 1X | 99% | 1% | +1%/−3% muscle content |
| 2X | 93% | 7% | +/−3% muscle content |
| 3X | 75% | 25% | +/−3% muscle content |

The variable speed conveyors 6006, 6008, and 6010 can be arranged in close and parallel proximity and located inside an ultra violet light (UV) tunnel shown as 6030 in FIG. 24. Tunnel 6030 can be arranged so as to expose any of the selected boneless beef to sufficient UV light so as to substantially sterilize the surfaces of the boneless beef. A suitable device of turning and/or rotating the boneless beef can be provided in the tunnel, so as to ensure that substantially all external surfaces of the boneless beef are exposed to the UV light to ensure the sterilization of the surfaces. Similarly, the variable speed conveyors 6018, 6020, and 6022 can be arranged in close and parallel proximity and located inside an ultra violet light (UV) tunnel shown as 6032 in FIG. 24. Tunnel 6032 can be arranged so as to expose any of the selected boneless beef to sufficient UV light so as to substantially sterilize the surfaces of the boneless beef. A suitable method of turning and/or rotating the boneless beef can be provided in the tunnel, so as to ensure that substantially all external surfaces of the boneless beef are exposed to UV light to ensure sterilization of surfaces.

The variable speed conveyors 6006, 6008, 6010, 6018, 6020, and 6022 can be provided with independent drivers and arranged to pass through a tunnel with a device to independently measure the fat and muscle content of the boneless beef carried on each individual and separate conveyor. Any suitable method of measuring the fat and muscle content of the boneless beef may be integrated with the conveyors 6006, 6008, 6010, 6018, 6020, and 6022 so as to provide a method of separate and continuous measurement of the fat and muscle content of the boneless beef separately carried on each conveyor. The variable speed conveyors 6006, 6008, and 6010 can be arranged to converge and deposit the boneless beef, carried by each independent conveyor onto a conveniently located secondary conveyor shown as 6034. Similarly, the variable speed conveyors 6018, 6020, and 6022 can be arranged to converge and deposit the boneless beef, carried by each independent conveyor onto a conveniently located secondary conveyor shown as 6036. The speed of each conveyor can be varied in direct relationship to the variation of measured fat and muscle content of the boneless beef carried by each conveyor.

The length of the variable speed conveyors 6006, 6008, 6010, 6018, 6020, and 6022 can be extended so as to allow operators, such as carcass disassembly workers, to deposit the boneless beef raw material thereon immediately after disassembly and separation from an animal carcass source of the boneless beef. Furthermore, the carcass disassembly workers can, for example adjust the fat content of boneless beef that is deposited onto each of the conveyors 6006, 6008, 6010, 6018, 6020, and 6022 according to requirements. More specifically, if it is determined by the fat measuring device that a reduced quantity of fat and an increased relative quantity of muscle (lean) tissue is required on any particular conveyor, this can be accommodated. Conversely, if it is required to deposit an increased relative quantity of muscle tissue onto any particular conveyor, this also, can be accommodated. In this way, the fat and lean content of the boneless beef that is deposited onto each of the individual conveyors can be adjusted to suit requirements which can be determined by the fat content measuring method through which each of the conveyors can be arranged to pass. Boneless beef can be deposited onto variable speed conveyors 6006, 6008, and 6010 according to requirements and by varying the speed of each conveyor and therefore the quantity of boneless beef carried and deposited onto conveyor 6034, a combined stream of boneless beef including fat and muscle tissue with a desired and constant relative ratio can be produced and carried on the conveyor 6034. Similarly, with variable speed conveyors 6018, 6020, 6022, boneless beef can be deposited onto each conveyor according to requirements and by varying the speed of each conveyor and therefore the quantity of boneless beef carried and deposited onto conveyor 6036, a combined stream of boneless beef, carried on conveyor 6036 and including fat and muscle tissue with a desired and constant relative ratio, can be produced and carried on the conveyor 6036.

Referring again to FIG. 24 and in particular to conveyor 6034, it can be seen that boneless beef carried on 6034 will be carried and deposited into meat grinder 6038. Similarly, it can be seen that boneless beef carried on conveyor 6036 will be carried and deposited into meat grinder 6040. By adjusting the ratio of fat and muscle content of boneless beef carried on each conveyor 6006, 6008, and 6010 and adjusting the speed and therefore the volume of boneless beef carried on each conveyor, a single stream, indicated as stream 6042, of boneless beef including fat and muscle tissue of a desired ratio can be provided and carried forward on conveyor 6034. Similarly, by adjusting the ratio of fat and muscle content of boneless beef carried on each conveyor 6018, 6020, 6022 and adjusting the speed and therefore the volume of boneless beef carried on each conveyor 6018, 6020, and 6022, a single stream, indicated as stream 6044, of boneless beef including fat and muscle tissue of a desired ratio can be provided and carried forward on conveyor 6036.

In this way, boneless beef stream 6042 may include boneless beef with a fat and muscle content of about 95% lean muscle and about 5% fat with a fat content variation of about +/−0.3%. Boneless beef stream 6044 may include boneless beef with a fat and muscle content of about 80% lean muscle and about 20% fat with a fat content variation of about +/−0.3%.

Boneless beef stream 6042 is carried forward by conveyor 6034 and deposited into grinder 6038. Conveyor 6034 and grinder 6038 may be enclosed inside a substantially sealed outer covering with a suitable gas such as nitrogen contained therein in such a manner so as to substantially exclude ambient air from presence therein. The boneless beef carried in stream 6042 is ground in the grinder 6038 and transferred through tube 6046 and into hopper 6048. It can also be seen that the boneless beef stream 6044 is carried forward by conveyor 6036 and deposited into grinder 6040. The conveyor 6036 and grinder 6040 may also be enclosed inside a substantially sealed outer covering with a suitable gas such as nitrogen contained therein in such a manner so as to substantially exclude ambient air from presence therein. The boneless beef carried in 6044 is ground in grinder 6040 and transferred through tube 6050 and into hopper 6052.

Stream 6042 of ground beef is then transferred by a pump, such as a positive displacement pump 6054, from hopper 6048 into and through static blending tube 6056 and into hopper 6058. Stream 6044 of ground beef is then transferred by a pump, such as a positive displacement pump 6060, from hopper 6052 into and through static blending tube 6062 and into hopper 6064. Positive displacement pumps 6054 and 6060 can be fitted with variable speed drivers Hoppers 6058 and 6064 can be substantially filled with a suitable gas such as carbon dioxide or any other suitable substance, and both hoppers 6054 and 6060 are arranged to have an adequate capacity to accommodate any quantity variations in normal production of boneless beef that may result from any variable requirement.

Hopper 6058 is connected with three positive displacement pumps shown as 6066, 6068 and 6070. Any number of pumps may be provided and connected to hopper 6058. Similarly, hopper 6064 is connected with three positive displacement pumps shown as 6072, 6074 and 6076. Any number of pumps may be provided and connected to hopper 6064. Each of the positive displacement pumps shown as 6066, 6068 and 6070 can be fitted with suitable, independently controlled, variable speed drivers such that any required quantity of ground boneless beef contained in hopper 6058 can be pumped therefrom at a desired velocity, and through a measuring device, such as the Epsilon GMS-40 shown as 6078, 6080 and 6082. Similarly, each of the positive displacement pumps shown as 6072, 6074 and 6076 can be fitted with suitable independently controlled, variable speed drivers such that any required quantity of ground boneless beef contained in hopper 6064 can be pumped therefrom and through a measuring device, such as the Epsilon GMS-40 shown as 6084, 6086 and 6088.

The Epsilon GMS-40-40 Meat Analyzer is a fat measuring device and is commercially available from Epsilon Industrial, 2215 Grand Avenue Parkway, Austin, Tex., 78728. Specifications for the GMS-40 are available from this supplier and information is also available from their web site at www.epsilon-gms.com. While this component is specified herein, other suitable fat measuring devices can be used as an alternate for fat and/or muscle content measurement.

As can be seen in FIG. 24, Epsilon GMS-40 measuring devices shown as 6078 and 6084 are attached directly to junction box 6079, Epsilon GMS-40 measuring devices shown as 6080 and 6086 are attached directly to junction box 6081 and Epsilon GMS-40 measuring devices shown as 6082 and 6088 are attached directly to junction box 6083. Suitably sized tubes connect pumps directly to corresponding Epsilon measuring devices as shown. The fat content of ground beef that is pumped by pump 6066 through the connecting tube and directly through Epsilon GMS-40 measuring device 6078, is measured by device 6078. The fat content of ground beef that is pumped by pump 6072 through the connecting tube and directly through Epsilon GMS-40 measuring device 6084, is measured by device 6084. The ratio and percentage quantity of fat in each separate stream of ground beef pumped by pumps 6066 and 6072 can therefore be measured and compared and the pumping rate of pumps 6066 and 6072 can be automatically adjusted according to the respective fat content of each stream of ground beef so as to provide a single stream of ground beef, after combining in junction box 6079, with a desired fat content. In this way selected quantities of boneless ground beef can be pumped directly from hopper 6058, containing ground beef from stream 6042 and hopper 6064, containing ground beef from stream 6044, by pumps 6066 and 6072, respectively, and through Epsilon GMS-40 measuring devices, shown as 6078 and 6084, into junction box 6079. Similarly, selected quantities of boneless ground beef can be pumped directly from hopper 6058, containing ground beef from stream 6042 and hopper 6064, containing ground beef from stream 6044, by pumps 6068 and 6074, respectively, and through Epsilon GMS-40 measuring devices, shown as 6080 and 6086, into junction box 6081. Selected quantities of boneless ground beef can be pumped directly from hopper 6058, containing ground beef from stream 6042 and hopper 6064, containing ground beef from stream 6044, by pumps 6070 and 6076, respectively, and through Epsilon GMS-40 measuring devices, shown as 6082 and 6088, into junction box 6083.

Selected quantities of ground meat from stream 6042 and stream 6044 can be combined in junction boxes 6079, 6081, and 6083. By varying the pumping rate of variable speed positive displacement pumps 6066 and 6068, a selected blend of ground beef, with a pre-determined and known ratio of fat to lean muscle tissue, can be pumped into junction box 6079. The fat content of the selected blend of ground beef pumped into junction box 6079 may be, for example, about 10%+/− about 0.3%. Alternatively, the fat content of the selected blend pumped into junction box 6081 may be, for example, about 15%+/−0.3%, and the fat content of the selected blend pumped into junction box 6083 may be, for example, about 17%+/− about 0.3%. By processing ground meats in this way, the fat content of any given production quantity of selected ground beef can be controlled within a narrow margin of variation, such as about +/− about 0.3% and the muscle and fat content selected as desired by adjusting the fat content of raw materials that are deposited onto conveyors 6006, 6008, 6010, 6018, and 6020, accordingly. Furthermore, the energy required to blend the ground beef in the methods described herein is much less than is typically required to produce ground meats using current industry practice.

The selected ground beef blend that is pumped into junction box 6079 by way of two streams from pumps 6066 and 6072 is then transferred through blender 6090. The selected ground beef blend that is pumped into junction box 6081 by way of two streams from pumps 6068 and 6074 is then transferred through blender 6092. The selected ground beef blend that is pumped into junction box 6083 by way of two streams from pumps 6070 and 6076 is then transferred through blender shown as 6094.

Blenders 6056, 6062, 6090, 6092, and 6094 are all conveniently arranged with gas injection ports shown as 6096. Gas injection ports 6096 are arranged to provide suitable gas, such as carbon dioxide, into blenders in such a way as to ensure that all ground meat that is pumped through the blenders is exposed to gas as desired and to an extent that will, for example, ensure that ground meat is saturated with dissolved suitable gas as required. Blenders 6056, 6062, 6090, 6092, and 6094 may include suitably sized continuous static mixing equipment such as may be supplied by Statiflo International, Macclesfield, Cheshire, UK. Any continuous blender may be integrated and located where indicated in FIG. 24 by blender reference numerals 6056, 6062, 6090, 6092, and 6094, or in any desired configuration that will ensure blending of ground meats as required.

The process described in association with FIG. 24 shows a combination of equipment that is configured to produce a first 6042 and a second 6044 stream of ground meat. Stream 6042 and stream 6044 are provided by measuring the fat content of two pair of three streams of boneless meat where streams 6012, 6014 and 6016 converge into a first stream 6042 and where streams 6024, 6026, and 6028 converge into a second stream 6044.

The fat and muscle (lean) meat content of stream 6042 is determined by the following factors: the total quantity of boneless meat deposited onto the conveyors that include the streams 6012, 6014, and 6016 and the fat and muscle content of the boneless meat, and the velocity of the streams 6012, 6014, and 6016.

Correspondingly, the fat and muscle (lean) meat content of stream 6044 is determined by the following factors: the total quantity of boneless meat deposited onto the conveyors that include the streams 6024, 6026, and 6028 and the fat and muscle content of the boneless meat, and the velocity of the streams 6024, 6026, and 6028.

The fat and lean content of streams 6042 and 6044 can be determined by adjusting the velocity of streams 6012, 6014, 6016, 6024, and 6028 and the fat content of the boneless meat provided into streams 6012, 6014, 6016, 6026, and 6028.

Referring to FIG. 24, streams 6098, 6102, and 6106 are shown to be connected directly to meat grinders 6100, 6104, and 6108. Grinders 6100, 6104, and 6108 are arranged to fine grind the corresponding stream of ground meat and transfer directly into a corresponding portioning apparatus. Grinder 6100 is arranged to fine grind ground meat in stream 6098 and transfer the stream of fine ground meat directly into portioning apparatus 6116. Grinder 6104 is arranged to fine grind ground meat in stream 6102 and transfer the stream of fine ground meat directly into portioning apparatus 6118. Grinder 6108 is arranged to fine grind ground meat in stream 6106 and transfer the stream of fine ground meat directly into portioning apparatus 6120. Any suitable variable speed driver may be integrated into equipment shown in FIG. 24 and may be controlled by a central processing computer.

The fat and muscle (lean) content of the stream of ground meat that is shown as stream 6098 and which is delivered to grinder 6100, is determined by the fat and lean content of a quantity of ground meat from both stream 6042 via pump 6070 and an additional quantity of ground meat from stream 6044 via pump 6076. The fat and muscle (lean) content of the stream of ground meat that is shown as stream 6098 is also determined by the velocity (and quantity of ground meat pumped therethrough) of the ground meat stream pumped into junction box 6083 by pump 6070 and the ground meat stream pumped into junction box 6083 by pump 6076. By adjusting the speed of pumps 6070 and 6076 the fat content of the ground meat in stream 6098 can be selected. The fat content of the ground beef in the stream pumped by pump 6070 is measured by the Epsilon (or other suitable fat measuring devices) fat measuring devices 6082. The fat content of the ground beef in the stream pumped by pump 6076 is measured by the Epsilon (or other suitable devices) fat measuring device 6086. The velocity of pumps 6070 and 6076 can therefore be controlled and set by the fat measurements provided by 6082 and 6086. In this way, a selected fat content can be produced by an automatic controller such as a computer that is connected to all associated pumps and fat measuring devices.

The fat and muscle (lean) content of the stream of ground meat that is shown as stream 6102 and which is delivered to grinder 6104, is determined by the fat and lean content of a quantity of ground meat from both stream 6042 via pump 6068 and an additional quantity of ground meat from stream 6044 via pump 6074. The fat and muscle (lean) content of the stream of ground meat that is shown as stream 6104 is also determined by the velocity (and quantity of ground meat pumped there along) of the ground meat stream pumped into junction box 6081 by pump 6068 and the ground meat stream pumped into junction box 6081 by pump 6074. Adjusting the speed of pumps 6068 and 6074 the fat content of the ground meat in stream 6102 can be selected. The fat content of the ground beef in the stream pumped by pump 6068 is measured by the Epsilon (or other suitable fat measuring devices) fat measuring device 6080. The fat content of the ground beef in the stream pumped by pump 6074 is measured by the Epsilon (or other suitable devices) fat measuring device 6080. The velocity of pumps 6068 and 6074 can therefore be controlled and set by the fat measurements provided by 6080 and 6074. In this way, a selected fat content can be produced by an automatic controller such as a computer that is connected to all associated pumps and fat measuring devices.

The fat and muscle (lean) content of the stream of ground meat that is shown as stream 6106 and which is delivered to grinder 6108, is determined by the fat and lean content of a quantity of ground meat from both stream 6042 via pump 6066 and an additional quantity of ground meat from stream 6044 via pump 6072. The fat and muscle (lean) content of the stream of ground meat that is shown as stream 6106 is also determined by the velocity (and quantity pumped there along) of the ground meat stream pumped into junction box 6079 by pump 6066 and the ground meat stream pumped into junction box 6079 by pump 6072. By adjusting the speed of pumps 6066 and 6072 the fat content of the ground meat in stream 6106 can be selected. The fat content of the ground beef in the stream pumped by pump 6066 is measured by the Epsilon (or other suitable fat measuring devices) fat measuring device 6078. The fat content of the ground beef in the stream pumped by pump 6072 is measured by the Epsilon (or other suitable devices) fat measuring device 6084. The velocity of pumps 6066 and 6072 can therefore be controlled and set by the fat measurements provided by devices 6078 and 6084. Any quantity of ground meat with any selected fat content can be produced by an automatic controller such as a computer that is connected to all associated pumps and fat measuring devices.

The configuration shown in FIG. 24 provides for automatic production of three streams of ground meat 6110, 6112, and 6114, each with a selected fat and lean content. A configuration of the required equipment, with any chosen capacity and size to suit any rates of production, can be arranged to produce any suitable number of one or more streams of ground meat, each with a selected fat and lean content, as may be desired.

Controlled Atmosphere Packages (CAP) are packages prepared or treated in an oxygen deficient atmosphere to remove or prevent the accumulation of oxygen within the package materials. Packages are overwrapped with apparatus having web stretching capabilities in one aspect of the invention.

Referring to FIGS. 25-27, details of a controlled atmosphere packaging system according to the present invention is shown. FIG. 25 shows a section of PVC web material 6200 that is about 0.0008″ in thickness. Any suitable thickness or gauge can be used. Web 6200 can be coated, fully or in part and with any desired pattern such that parts of the web remain clear and other coated parts may be opaque. Web 6200 is shown with a suitable heat sealing coating that has been applied in two continuous strips along the edges of the web such that a continuous, central strip remains clear. The width of the clear section 6202 central strip may be about 50% of the total width of the web 6200 and the outer two printed sections 6204 of about equal width being about 25% of the full width each, of web 6200 such that when formed into a tube 6214, a fin seal 6208, can be provided by heat sealing there together. A sealed tube can include an upper clear section 6202 through which the tray 6210 can be seen and a lower, opaque section 6212 through which tray 6210 cannot be seen.

Web 6200 can be processed by a modified Hayssen RT1800, for example, in such a manner so as to form a continuous tube 6214, and shown as PVC web material “fin” sealed tube. Suitable packaging trays such as Mono-Pak™ trays 6210 that have been filled with perishable goods such as ground beef can be inserted into the tube 6214, by automatic devices (not shown) or any other suitable devices, and lateral stretching can be induced into the tube 6214. The lateral stretching can cause the tube 6214 material to firmly contact the tray 6210 and hold the perishable goods contained therein firmly. After the trays 6210 are located inside the fin sealed tube 6214 the tube can also be stretched longitudinally. After the longitudinal stretching of the tube 6214, lateral fin seals, followed by severing of the tube 6214 adjacent to the lateral fin seals, can be provided so as to provide a fully and hermetically sealed package as shown in FIG. 27. The lateral and longitudinal stretching can be provided prior to sealing and severing of the lateral fin seals. Longitudinal stretching can be effected by the modified Hayssen RT1800 as generally described below.

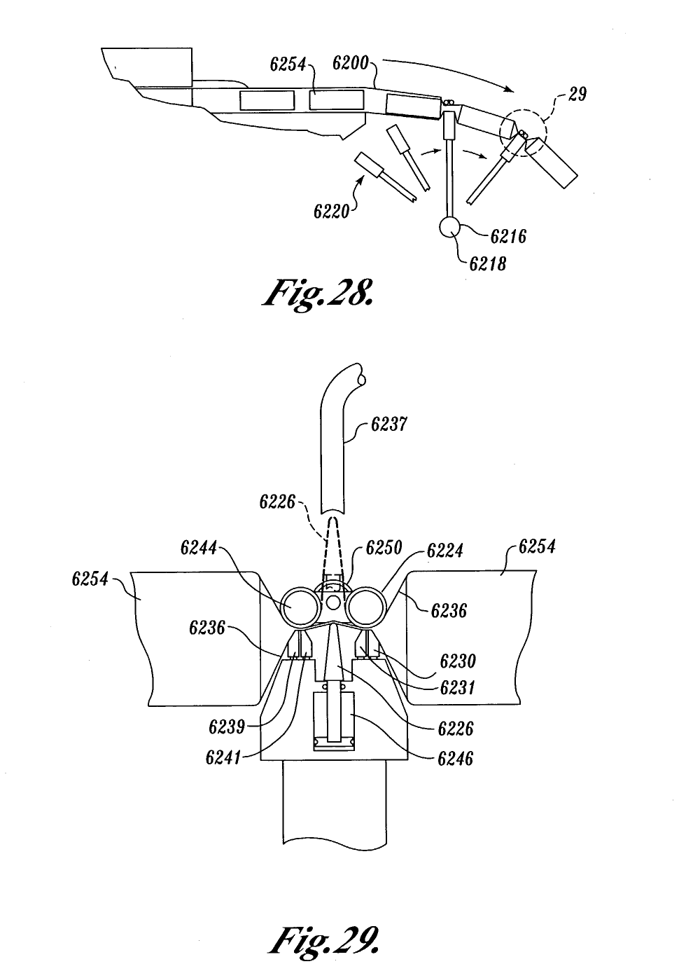

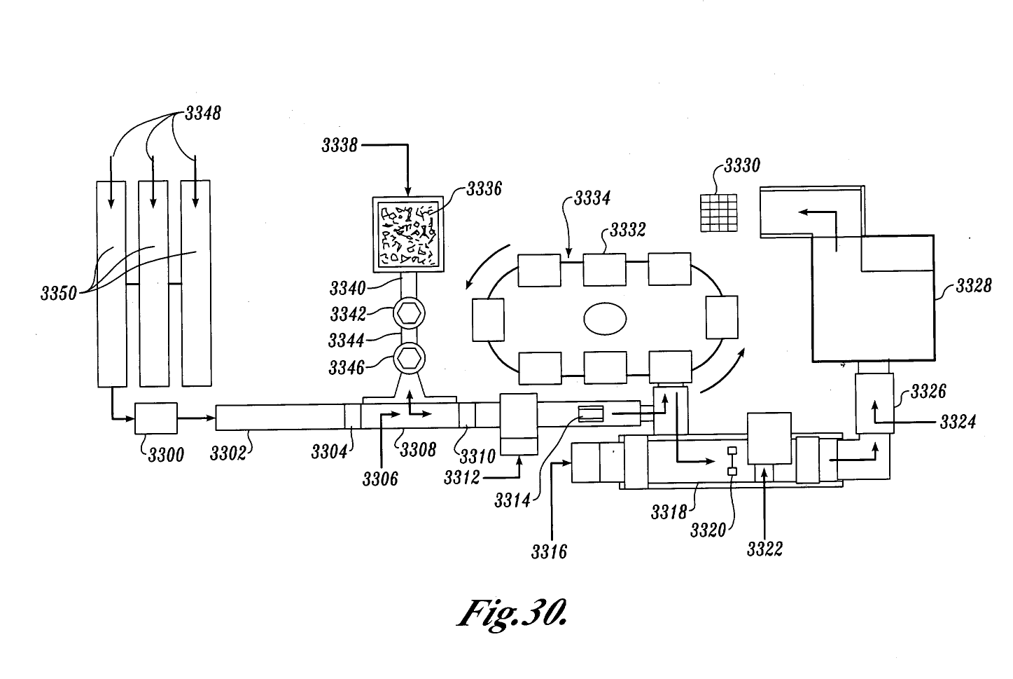

Referring again to FIG. 24, items 6150, 6148, and 6146 include three modified versions of the Hayssen RT1800 (modified RT1800), flow wrapping packaging machine. The modifications to each item 6150, 6148, and 6146 refers to the inclusion of a sub-assembly to each machine which is detailed in a cross-sectional sketch, shown as FIGS. 28 and 29, so as to enable processing and use of pPVC web material on the RT1800 packaging machines. The following disclosure details the modification that can be incorporated in the RT1800 so as to facilitate the use of pPVC web material as the over wrapping packaging material used thereon to over wrap such packages as the Mono-Pak EPS foam tray.

The Hayssen RT1800 is manufactured by Hayssen, a division of the Barry-Wehmiller Company, which is located at 225 Spartangreen Boulevard, Duncan, S.C., 29334. Other information describing the RT1800 can be obtained from the following web site: www.hayssen.com. The RT1800 incorporates a “rotary die wheel” to provide a continuous movement of the web during machine operation and package sealing. This arrangement provides a method to process and seal packages more rapidly than other types of over wrapping machines, but the RT1800 has not been used to over wrap packages with pPVC (plasticized polyvinylchloride) web material.

It is desirable to use pPVC web material, in this particular application, because of its physical characteristics for the packaging of fresh meats such as ground meats and poultry pieces. However, the standard RT1800 is not ideally suited to process pPVC web material and in order to ensure efficient stretching and sealing of the pPVC web, the modifications to the RT1800 are necessary.

The HAYSSEN RT1800 rotary die wheel concept operates on the principal of maximizing dwell time. Individual MAGNUM sealing dies are released on demand as packaging material and product move through the machine. The RT1800 packaging equipment is well known to those skilled in the arts and all details of the RT1800 machine construction are readily available from the manufacturer to potential end users of this popular packaging equipment.

Packaging materials may include the Mono-Pak™ EPS tray, over wrapped with plasticized PVC web material, (supplied by AEP/Borden or Huntsman).

It should be noted that the readily available, low cost, pPVC web material as intended for use in this application, has the following properties:

Glass clarity

Stretch and high extensibility (50-100% before exceeding elastic limit)

Memory, providing a “return to its original condition” after stretching (within elastic limit).

Standard, enhanced oxygen permeability.

Rapid heat sealing to itself.

Rapid hot “knife” cutting, providing clean cut edges.

Generally, the basic RT1800 machine, as manufactured by Hayssen, would remain similar to existing standard equipment, except for the modification described herein. The existing longitudinal fin or lap sealing (shown as 6208 in FIG. 26) may require adjustment to facilitate an enhanced lateral web “stretching” capability for a pPVC web. The longitudinal web stretching apparatus, as disclosed herein, should be capable of installation without major structural and basic frame modifications to the existing equipment.

FIGS. 28 and 29 include an assembly intended for optional and interchangeable use on a standard Hayssen RT1800 or similar packaging machines.

Referring to FIGS. 28 and 29, the apparatus constructed according to the present invention includes a die wheel 6216 shown in part with the axis of the wheel marked as axis 6218. A number of die carriers 6220 are also shown. The complete die wheel 6216 and drive is not shown, however, since a person skilled in the art will readily recognize the proposed modification when viewing the representation of the die wheel with die carriers as shown. The wheel die assembly fixture may include standard Hayssen components modified to conveniently suit the attachment of the “Stretch Web Clamp Assembly” of the invention.

The packaged product may come in any of the trays disclosed herein, over wrapped with standard (with enhanced O₂ permeability) plasticized PVC web material (supplied by AEP/Borden or Huntsman). The EPS material can be produced with a surface finish that will not “cling” to the pPVC web material. Plasticized web of stretch over wrap material can be printed or plain material can be used. Partial coating of the inside web surface, with a low melt heat activated coating (HAC), can provide for improved performance.

Referring to FIG. 29, a full width, lateral, impulse, heat sealing, element 6231 (e.g., cut from Inconnell SS sheet or other “marine” grade, SS sheet material) is installed by attachment to a horizontally disposed rigid and suitably heat tolerant, non metallic base. Compensation for normal expansion and contraction of the element, during heating and cooling, can be provided. The element is covered with suitable material (PTFE) so as to provide a “non-stick” surface that will not “cling” to pPVC web. The heat sealing assembly is arranged with the heat sealing element 6231 in close, adjacent, and parallel disposition to a full length strip of a portion of the outer surface of roller 6224, as shown in FIG. 29. When held together under suitable pressure with two webs of pPVC material located between member 6231 and roller 6224, a full length and hermetic seal between the two webs can be produced.

An alternative heat sealing device includes a heat bank. Use of either impulse or heat bank devices may be determined by manufacturer preference. In the case of a heat bank device, the clamping bars 6230 and 6239 would be separated and insulated from the adjacent heat bank members 6231, 6241. Members 6230, 6239, 6231, and 6241 would require independent return spring mounting. A suitable distance or gap (for insulation and sealing/cutting control devices) between the elevation of the clamping surface of the clamping bar and the elevation of the contact surface of the heat bank would be required. This would allow clamping of the web(s) 6236 by the clamping bar with subsequent web clamping, sealing, and cutting by the heat bank.

Web clamping bar 6230 includes a strip like component that is arranged in parallel and close proximity to assembly 6231 so as to clamp web 6236 at the same time and with similar clamping effect as member 6230 when roller 6224, 6230 and member 6231 are engaged.

Rubber coated roller 6224 with cam/clutch bearing includes a heat resistant rubber coated and suitably ground, solid steel, hardened, rigid roller. Roller 6224 is located between two end plates (not shown) and mounted thereto by a bearing (one located at each end of the roller 6224). The bearings are of identical dimensions with a “cam/clutch” feature provided in only one bearing. Such arrangement allows the roller 6224 to rotate in a clockwise direction only.

Impulse heat sealing element assembly 6241 is arranged to mirror assembly 6231.

Web clamping bar 6239 is arranged to mirror web clamping bar 6230.

Rubber coated roller 6244 with cam/clutch bearing includes a heat resistant rubber coated, solid steel, hardened, rigid roller identical to roller 6224 but with a “cam/clutch” feature provided in only one bearing so as to allow roller 6244 to rotate in a counter clockwise direction only. The surface finish on both rollers 6244 and 6224 can be arranged so as to cling to web 6236 when contact occurs between suitably tensioned web 6236.

Two end plates 6240 and 6242 are arranged to rigidly retain rollers 6244 and 6224 in relative, respective, parallel, and separated proximity, allowing the rollers to rotate as described above. Both end plates may be fitted with suitable coil or flat return springs to hold the rollers 6244 and 6224 in a normal position at a desired distance from bars 6230 and 6239 and heating elements 6231 and 6241.

A cam follower is mounted to each end plate 6240 and 6242 so as to engage with cam tracks (not shown but mounted to main frame of the Hayssen FFS machine) arranged to provide a web sealing pressure to web 6236 by causing depression of end plate return springs.

The web stretching bar 6226 includes a strip of suitable material profiled as shown and provided with an outer surface treatment that can cling to pPVC web material. Web stretching bar 6226 is attached to two pneumatic cylinders [6246 (shown) and 6248 (not shown)] with slotted fixture apertures so as to eliminate locking that may otherwise occur during operation. The web-stretching bar is shown in a normally withdrawn (closed) position and also in a fully extended position, by dotted lines. When in the normally closed position, the upper and highest edge of the bar extends along its full length and is in permanent contact with web(s) 6236. This contact is arranged so as to ensure a suitable tension is induced in the web(s). This can provide a condition allowing the free movement (by stretching) of the web material over roller's 6244 and 6224 only inwardly and toward the web-stretching bar. The cam/clutches installed in the rollers will not allow the web to be pulled away from the web-stretching bar. Web 6236 can be freely stretched but is essentially clamped by its tensioned and intimate contact with the surface of the rollers and the upper edge of the web-stretching bar.

The roller assembly includes two of each of rollers 6244 and 6224, endplates 6240 and 6242, cam followers 6250 and 6252, and fasteners and return springs as required. When assembled with the complete web stretching assembly and in a normally closed position, a suitable gap is maintained between the rollers and the adjacent contact surfaces of items 6230, 6231, 6239, and 6241, thereby allowing free stretching of the web 6236, by activation of web-stretching bar 6226.

A pneumatic cylinder 6246 is shown, attached to the web-stretching bar 6226 to extend bar 6226 to the position shown by dotted lines and thereby stretch the web 6236. Two cylinders would be provided. Compressed air flow and pressure controls can be arranged to activate cylinders 6246 and 6248 so as to optimize induced tension in web 6236. Any suitable alternative method of web-stretching bar activation and control may be used. A vacuum tube 6237 may be conveniently located so as to provide a method of removing scrap web material (excess material for accumulation in a canister).

In one configuration, independent pivoted mounting of each roller and clamping assembly is provided. Each assembly is held in the normal central position (close together), by controlled return springs. Activation of the web-stretching bar 6226 will cause the two assemblies to move away from the central position until contact with the packages 6254. Such an arrangement will provide consistent web stretching with a final web heat sealing at a constant distance from the package. In this configuration, end plates 6240 and 6242 would require slotting to accommodate outward rotation of each assembly.

Products, pre-filled with ground beef portions/blocks, are automatically loaded onto the entry end of the Hayssen FFS equipment. Orientation of the products may be in normal or inverted disposition. A normal disposition (with package “open top” side facing upward) would require a side fin or lap web seal, whereas an inverted disposition would require a bottom web seal. Normal operation would include longitudinal sealing after induction of maximum stretch in web 6236. Lateral sealing would occur after longitudinal stretching by web stretching bar 6226. Activation of the web-stretching bar would not commence until closure of the subsequent closing of the closest clamp to its rear, on the wheel. In this way gradual stretching of the pPVC over wrap, during the wheel rotation, can occur until the desired level of stretch and/or tension is achieved when web heat sealing and simultaneous cutting could be provided immediately prior to ejection of the finished package(s). The finished packages could be ejected in a normal and upright disposition, assuming that the packages were loaded in an inverted disposition, alternatively, the packages could be inverted after ejection if the packaging had been loaded onto the RT1800 packaging machine in a normally upright position.

By incorporating the above-described modification in the Hayssen RT1800 packaging machine a web stretching arrangement is provided to stretch the over wrap material 6236 during the normal rotation of the die wheel. It is anticipated that, in view of the rapid heat sealing and cooling characteristics of thin gauge (0.0008″) pPVC, the operational speed of the Hayssen RT1800 could be increased to more than 1800 feet per minute.

Referring now to FIG. 30, one embodiment of an equipment layout according to the present invention includes three rectangular components being identified by the reference numeral 3350. Equipment 3350 is a diagrammatic representation of an alternative equipment configured to exchange air and atmospheric oxygen, contained within the cell structure of foamed polystyrene trays (EPS trays) and foamed polyester trays (FP trays). This equipment includes three similar components. Each component is arranged to form a horizontally displaced, rectangular or square tube with doors at each end. The tube is conveniently positioned so that access to the doors at each end of the tube can be accessed for loading of packaging materials into the tube. When the doors are shut, the tube is sealed to provide a fully enclosed container or enclosure in which the EPS or FP trays can be stored. Conveniently located ports are provided into the walls of the tube such that suitable gases can be introduced as required within the tube thereby displacing substantially all atmospheric air and most particularly atmospheric oxygen therefrom.

The tube is loaded with quantities of EPS and/or FP trays and the doors are closed to provide a sealed container. Nitrogen, other inert and/or any other suitable gases are provided into the tube so as to displace substantially all air from the interior of the tube and thereby providing a condition where the gas is in contact with the surface of the EPS and/or FP trays. An ozone generator may be installed and chlorine gas may be provided within the enclosure. Any gases and most particularly oxygen, that may be present within the cells of the trays can therefore freely diffuse and exchange with the gas in contact with the tray surfaces. With the passage of time, gas contained within the cell structure of the tray walls will therefore be displaced with gas in contact with the outer surface of the trays. Oxygen gas will be substantially removed from the cell structure. Oxygen will gradually accumulate and the level of “free” residual oxygen remaining in the tube can be monitored by automatic gas analysis and maintained at a minimum and desired level. This is achieved by extracting gases from within the tube at a point near an end of the tube while providing an equal quantity of additional oxygen free gas into the tube at a point near to the opposite end of the tube from the extraction point at the other end of the tube.

Equipment 3302 is a tray sealing apparatus which is arranged to produce packages, including tray, web and perishable goods contents shown as ground meat. The perishable goods may be portions of beef, pork or any other suitable perishable goods.

Equipment 3318 is for producing substantially gas barrier “master containers” from a roll of suitable material 3316. Equipment 3318 may be a Multivac R 530 that has been adapted to suit the production system of the present invention. Equipment 3320 can be provided for (optionally) locating an oxygen absorber into each master container with the retail packages before sealing a barrier lid to the master container. The barrier lid material 3322 includes a roll of the barrier plastics lid material.

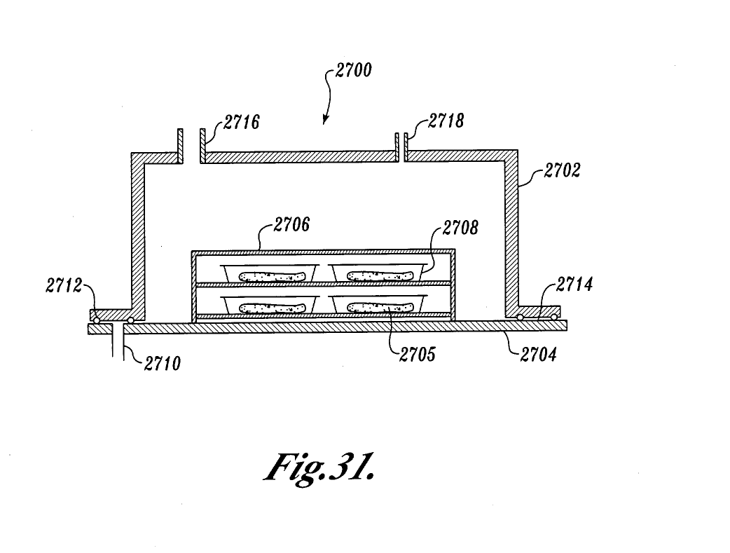

Apparatus 3334 shown in FIG. 30 represents a typical carousel style vacuum packing machine, such as an “Old Rivers” equipment that has 8 vacuum chambers fitted thereto. The carousel style vacuum packing machine, 3332, is shown fitted with 8 vacuum chamber assemblies similar to that as shown in FIG. 31 and described herein. Referring now to FIG. 31, a closed vacuum chamber 2700 including upper vacuum chamber 2702 and lower vacuum plate 2704 is shown. A rack 2706 with trays 2708 containing perishable goods, such as red meat, are shown inside closed vacuum chamber 2700. An evacuation port 2710 in direct communication with a source of vacuum is provided. A switch is attached to the vacuum source so as to provide on/off control. Two continuous and concentric ‘O’ rings 2712 are located between the edges of vacuum chamber 2702 and lower plate 2704 and spaced apart, providing a space 2714 therebetween. The distance between ‘O’ rings is arranged such that when multiplied by the length of space 2714 the total projected area between the concentric ‘O’ rings can be calculated. When a vacuum is applied to port 2710, the closing force created between 2702 and 2704 can be determined. A gas or blend of desired gases can be provided within the closed vacuum chamber at a pressure above atmospheric pressure which will provide a chamber opening force. However, in this arrangement, the closing force can be arranged to exceed the opening force thereby providing a method of maintaining a pressure with the closed chamber at a level above that of the prevailing atmospheric air pressure while the closed vacuum chamber remains closed due to the closing force provided. A further evacuation port 2716 is provided in chamber 2702 and a gassing port 2718 is provided also. The upper vacuum chamber 2702 is arranged so that it can be lifted vertically upward and away from lower plate 2704 allowing removal of the rack with trays and another rack with trays can be placed therein such that a continuous production process can be undertaken. The upper vacuum chamber 2702 and the lower vacuum plate 2702 may be arranged with clamping and structural supports so as to allow an increase of gas pressure to any desired pressure such as 500 psi or more.

Perishable goods are located in an EPS (foamed polystyrene) tray with inherent or enhanced gas permeability. A gas permeable web is positioned above the EPS tray. The web has adhesive applied to the region of the web that will come into contact with flanges of the tray so as to provide a seal between web and tray. The web is then sealed to the flanges of the tray. The flange of the tray may be compressed to provide improved structural integrity and strength.

The EPS tray with inherent or enhanced gas permeability can quickly transfer, remove and exchange substantially all oxygen gas from foam cells during the process of carousel evacuation and gassing.

The web may be printed on one or both sides with panels that can be seen from the upper side after sealing to the tray. A bar code can be applied to a label on the underside of the package. The bar code can include code information such as the specific weight of tray contents, date packaged and type of content goods. Information can be read by a scanner at any time after packaging and converted to consumer readable information that can be printed by, for example, ink jet printers onto the panel prior to retail display.

A device to cause oscillation of gas pressure within the chamber at a frequency that will cause improved and more rapid exchange of air and oxygen contained within cells of EPS tray with desired gas provided in chamber, can be provided. Furthermore, the oscillation of gas pressure within the chamber, can cause the permeable web to raise and lower and provide a space between the web and upper surface of the goods thereby allowing the gas provided in the chamber to directly contact the tray contents beneath the web. Oscillation can also provide improved contact with the goods and enhanced absorption of the gases by the goods. The oscillation may be set at a range of gas pressures that are above or below prevailing atmospheric pressure. The gas may include other substances in vapor, atomized or powder form and the composition may be selected and include the most suitable blend of one or more of the following: nitrogen, oxygen, argon, carbon dioxide, hydrogen, krypton, neon, helium, xenon, O₃, F₂, H₂, O₂, KMnO₄, HClO, ClO₂, Br₂, and I₂.

A desirable blend of gases such as carbon dioxide and ozone can be provided within the closed chambers 2702 and 2704 with the rack with trays contained therein. Racks with trays can be automatically loaded into open vacuum chambers 3332, which are then closed. A vacuum source is then applied to port 2710 and a desired gas provided into the closed vacuum chambers after removal of atmospheric air there from. The carousel is rotated intermittently in the counterclockwise direction shown in FIG. 30 and stopped such that after each vacuum chamber assembly 3332 has fully traveled around the perimeter of the carousel, the rack with trays can be automatically removed from each vacuum chamber and replaced with another. Therefore, a continuous and automatic process of treating trays containing perishable goods with desired gases can be provided.

Referring now to FIG. 30, equipment 3326 is a diagrammatic representation of an automatic carton erecting, filling and sealing equipment. A supply of cartons is also shown as 3324.

Equipment 3328 is a representation of an automatic carton palletizer, such as model FL 100 manufactured by Columbia Machine, Inc., Vancouver, Wash. The palletizer is arranged to automatically palletize finished cartons of packaged perishable goods with a supply of empty pallets 3330. Finished cartons can be automatically transferred from equipment 3326 to the palletizer.

Equipment 3336 is a representation of equipment configured to receive, grind, condition and process meat and other similar perishable goods. Arrow 3306 is a representation of the direction of flow of an alternative perishable goods to be optionally loaded into the trays. Equipment 3340 is a meat grinder. Equipment 3342 is a pressure vessel. Equipment 3344 is a secondary meat grinder. Equipment 3346 is a pressure vessel. Equipment 3338 represents the perishable food item, such as portions of meat that are to be processed and packaged. Equipment 3304 is a diagrammatic representation of equipment configured to locate tray flange covering members prior to loading of the perishable goods into the tray. The flange covers are described in the Australian Patent Application No. PM8415. Equipment 3308 is a diagrammatic representation of a section of the packaging equipment that is exposed as required to facilitate efficient loading of the perishable goods into the trays. Equipment 3310 is a representation of equipment configured to remove tray flange covers as generally described in Australian Patent Application PM8415. Equipment 3312 is a representation of a roll of plastics lid material intended for sealing to flanges of the trays after perishable goods have been placed therein. Equipment 3314 is a representation of an optional feature and equipment for locating labels onto the underside or, after adjustment, upper side of the retail packages after sealing of lid material to flanges of the trays. Equipment 3318 is a representation of an apparatus for producing substantially gas barrier “master containers” from a roll of suitable material 3316, locating an optional oxygen absorbing material into each master container with the retail packages and sealing a lid to the master container that is unwound from a roll of plastics lid material shown as 3322. Equipment 3334 is a representation of a typical carousel type vacuum packaging machine that has been modified according to the description provided herein, and located adjacent to packaging equipment, so as to facilitate easy transfer of finished packages therebetween. Equipment 3332 is one of 8 vacuum chambers mounted to the carousel and as shown in FIG. 31. Equipment 3326 is a representation of an automatic carton erecting, filling and sealing equipment with a supply of cartons 3324. Equipment 3328 is a representation of an automatic palletizer.

Equipment 3300 is a representation of equipment configured to exchange air and more particularly, atmospheric oxygen, contained within the cell structure of foamed polystyrene trays (EPS trays) and foamed polyester trays (FP trays).

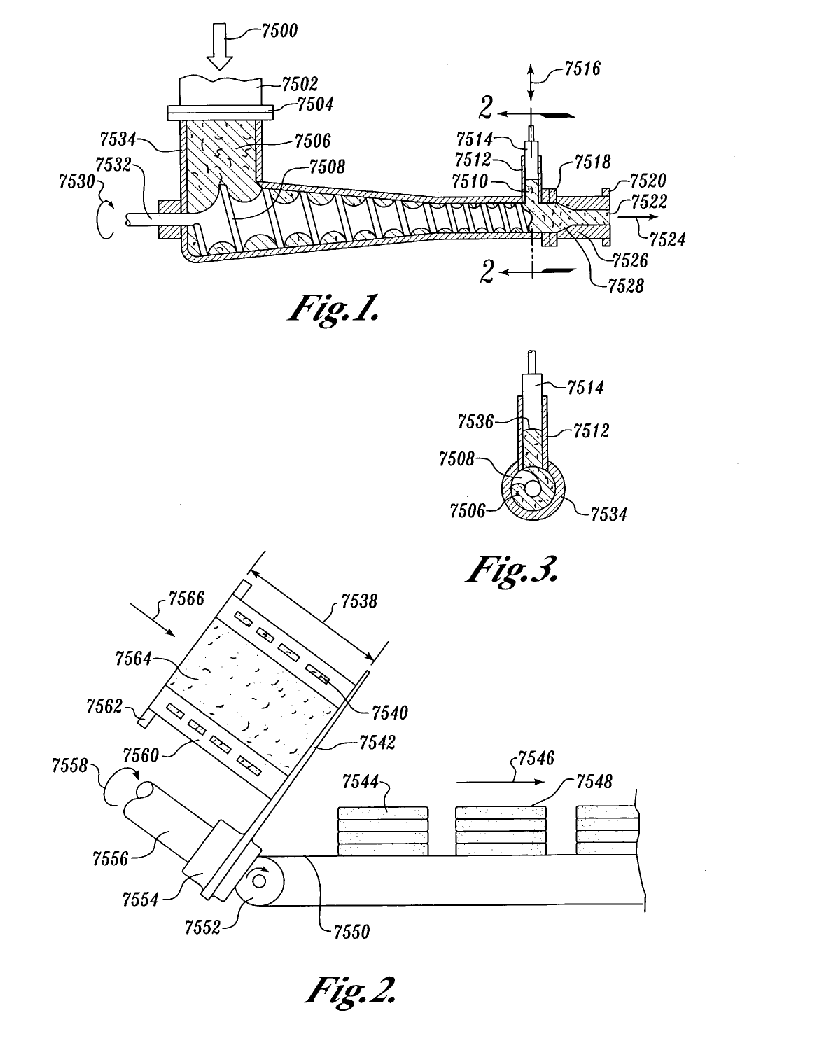

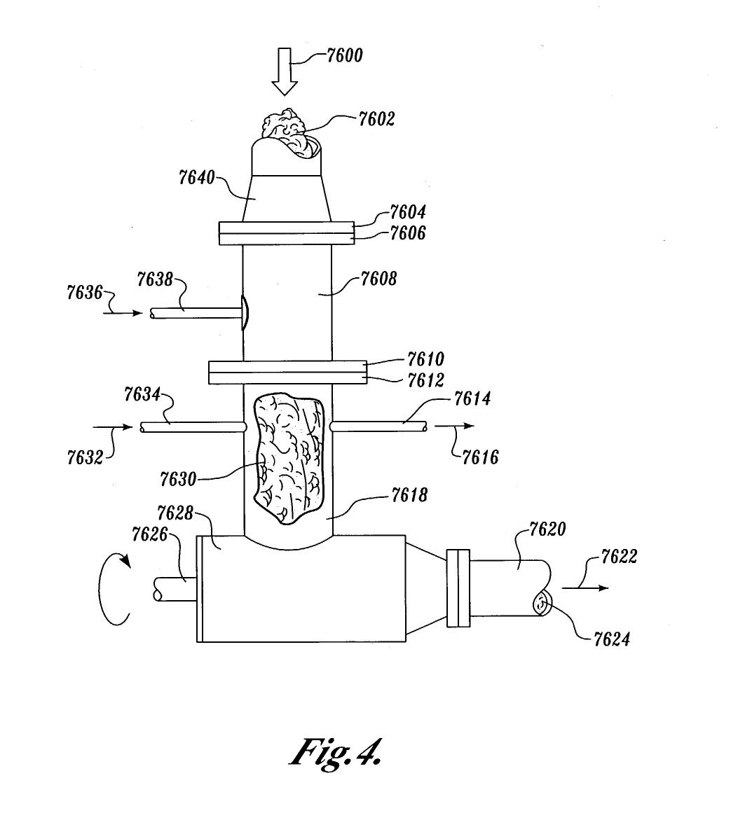

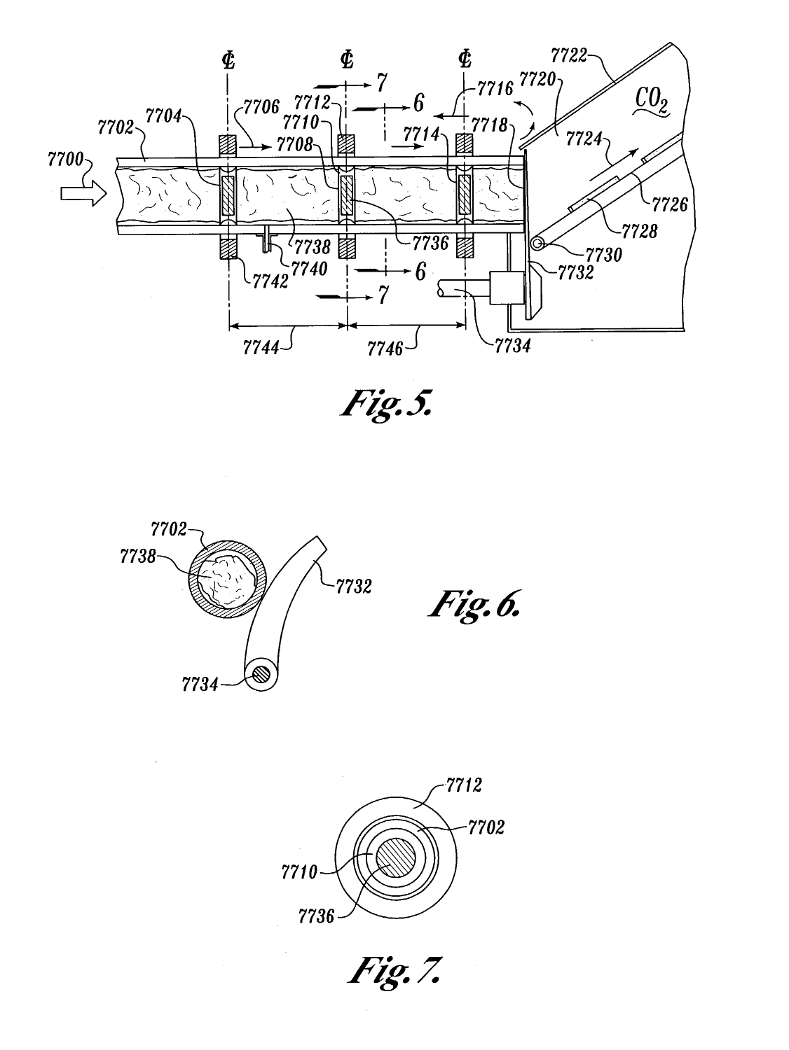

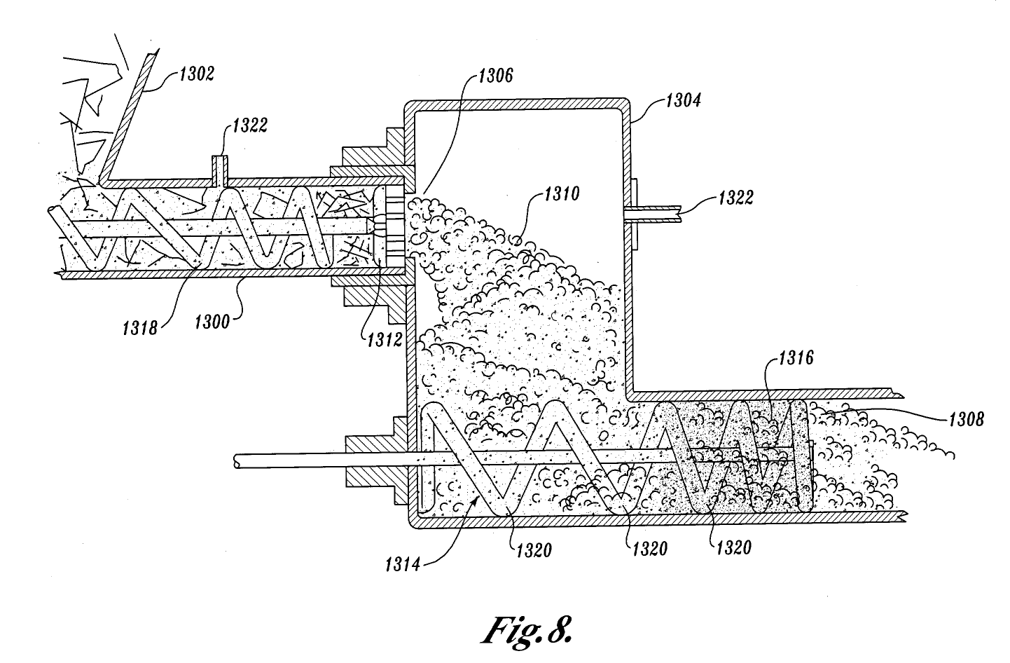

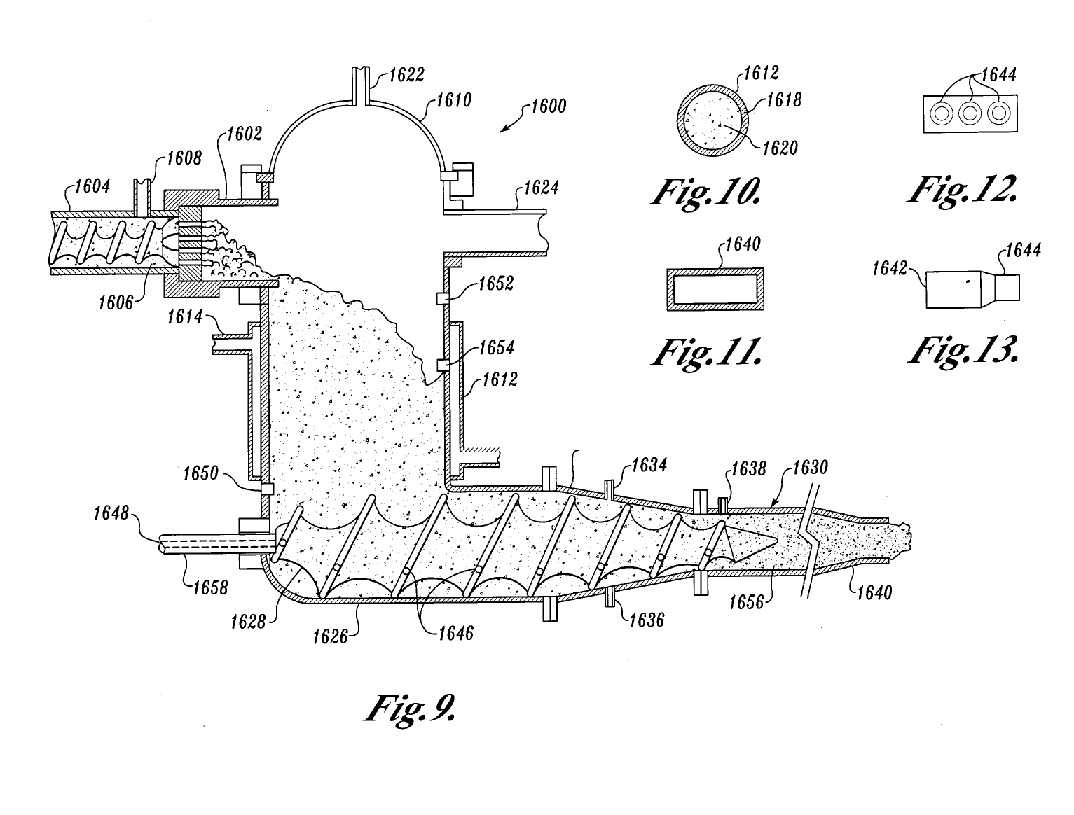

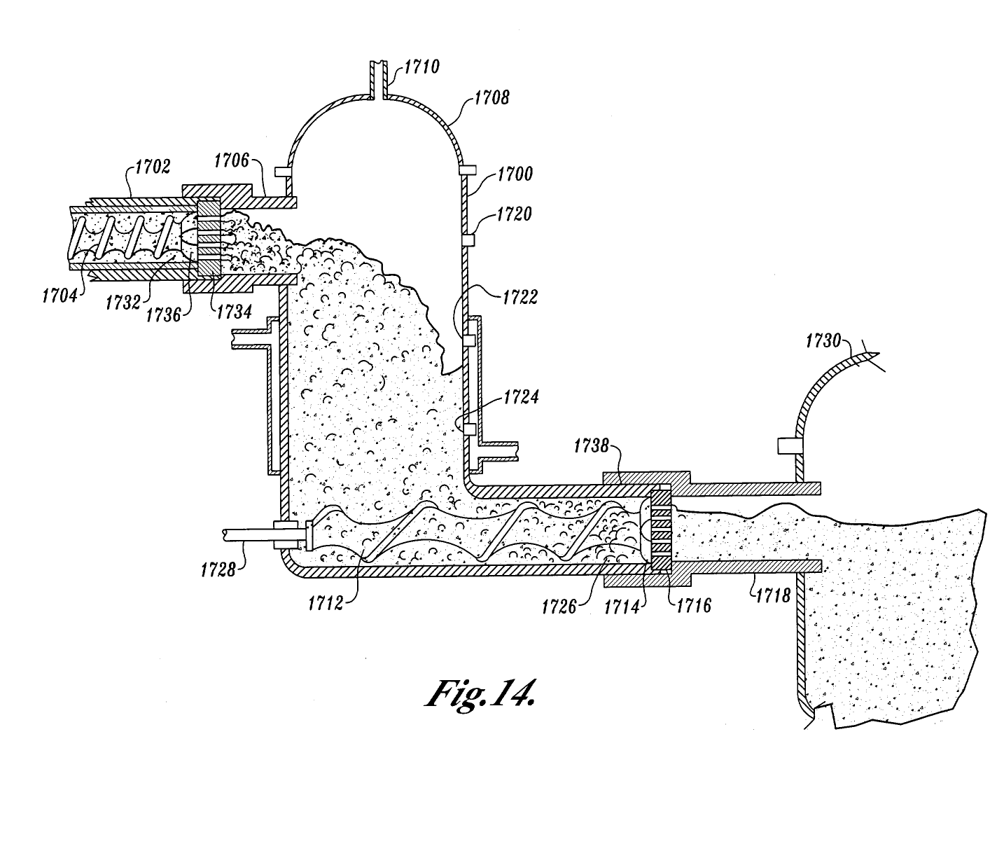

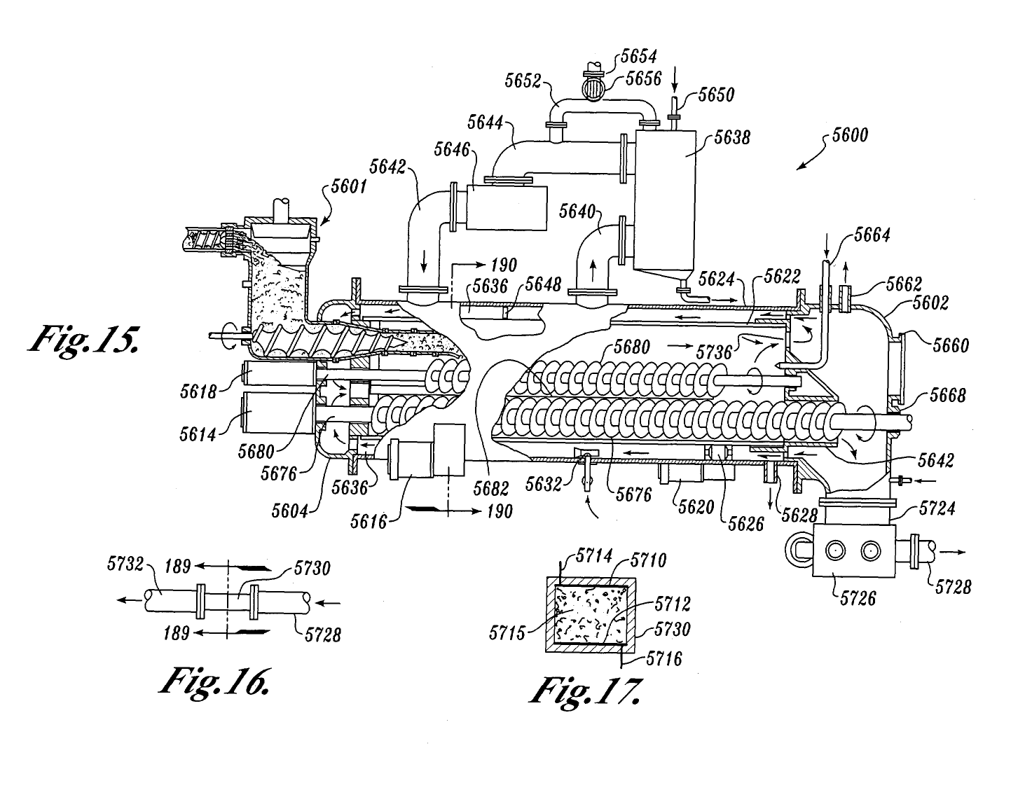

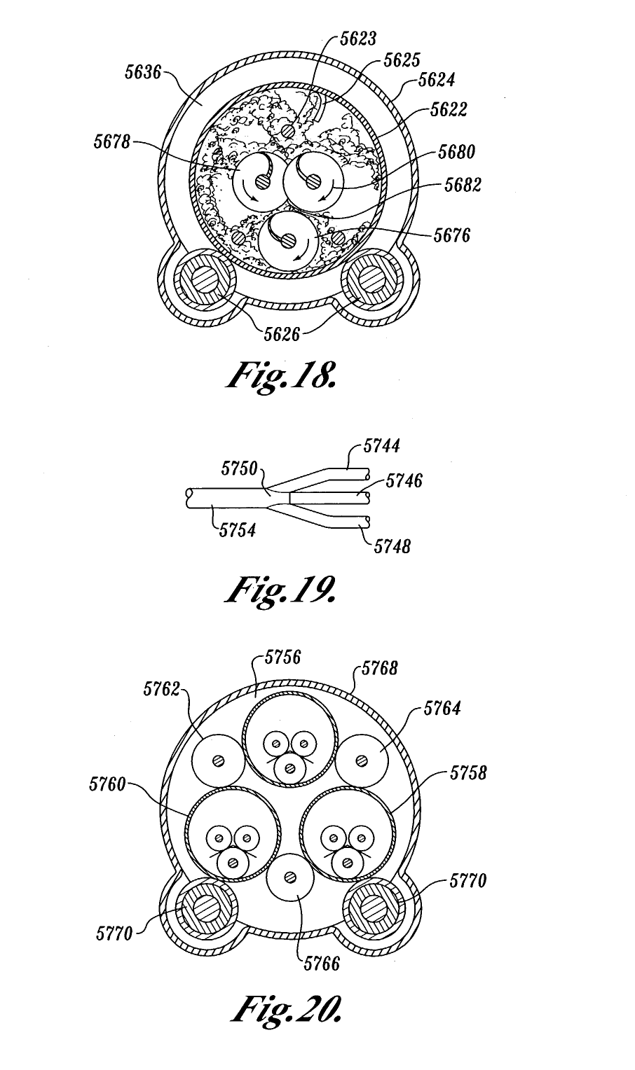

FIG. 1 shows a cross section through an apparatus that may be used for pumping pre-blended grinds into a profiled conduit thereby providing an extruded stream of grinds for subsequent slicing and production of patties. An enclosed housing 7534 is shown with a tapering screw 7508 mounted therein. The external surfaces of the tapering screw can be profiled to match the internal surface of housing 7534 such that these surfaces are in close but not touching proximity and so that the screw 7508 will scrape the internal surface of the housing 7534. The arrangement in FIG. 1 shows a single screw but may alternatively be arranged with parallel sides that are not tapered. In one embodiment, the screw is tapered and may be mounted in tandem and adjacent to a counter rotating, correspondingly matching, second tapering screw (not shown) in parallel therewith. Such a pair of matched and meshing screws can provide a means to scrape all surfaces of the screws and all internal surfaces of housing 7534. As shown in FIG. 1, screw 7508 is driven via a shaft 7532 attached to a suitable driving motor (not shown) such as a servo electric motor, which can drive the screw(s) in a direction indicated by arrow 7530 and at a variable speed. Pre-blended grinds 7506 that have been processed as required in enclosed vessels (not shown) that substantially excluded oxygen from contact thereto, are provided by any suitable transferring mechanism into conduit 7502 which is attached via a gas tight flange 7504 to housing 7534. Grinds 7506 provided into housing 7534 are substantially free of air or oxygen and any voids contained therein can be substantially filled with carbon dioxide. Grinds 7506 can be transferred into housing 7534 at a controlled temperature below the freezing point of water such as at 29.5 degrees F. Housing 7534 may be fitted with a suitable jacket and insulation with conduits provided therein (not shown) through which any suitable liquid, maintained at any suitable temperature, can be transferred. A piston 7514 is shown located within a cylinder 7512, which in turn, is mounted directly to housing 7504. Piston 7514 can be directly coupled to a driving mechanism (not shown) that will activate movement of the piston in a reciprocating manner with directions of movement shown by double headed arrow 7516. FIG. 3 shows piston 7514, cylinder 7512, grinds 7506, and screw 7508 and it can be seen that the end of piston 7514 is provided with a radius 7536, that matches the external radius of screw 7508 such that when piston 7514 is in close but not touching proximity to rotating screw 7508, the external surface of piston 7514 at 7536 will be wiped by the outermost edges of screw 7508 as it rotates. In this way, substantially no fat or grinds can accumulate by sticking to the exposed surface of piston 7514, at 7536. A single matching piston and cylinder assembly is shown mounted to housing 7534, however, more than one such matching assembly may be mounted in radial disposition to housing 7534. For example, three or four such matching piston and cylinder assemblies may be mounted around the circumference of housing 7534 and arranged to operate simultaneously or as may otherwise be required. Mounted to the exit end of housing 7534, a conduit 7526 is fixed in a sealed and gas tight manner. Conduit 7526 is shown with a restriction therein, such that the internal diameter at the point of entry is identical to the internal diameter of housing 7534 and the diameter of conduit 7526 is tapered so as to reduce the cross sectional area and therefore, when grinds are pumped there through, back pressure is generated against the exposed end surface 7536 of piston 7514. A flange 7520 is shown at the exit end of apparatus shown in FIG. 1 which may correspond with matching flanges of profiled conduits (such as 7560 in FIG. 2) that can be interchangeably attached thereto, to provide a different profile and size of extruded streams of grinds pumped there through. An arrow 7524 shows the direction of flow of extruded stream of grinds 7506.

In one embodiment, grinds 7506 are transferred into housing 7534 and carried in a forward direction, indicated by arrow 7524, by rotation of tapered screw 7508, in a continuous stream. During transfer through housing 7534, grinds 7506 are compressed so as to ensure any voids that may be contained therein are eliminated by dissolving of CO₂, contained in the voids, into said grinds. As stream 7506 is transferred in the direction shown by arrow 7524, a cone shaped conduit at 7526 further restricts stream of grinds 7506 and compresses it into a substantially void free stream exerting a back pressure that is proportionate to the velocity of stream 7506 and the restriction according to the diameter of conduit 7526. Alternatively, other suitable restrictive conduits or valves may be provided in place of conduit 7526. In order to provide a stream of grinds that has been conditioned to a suitable temperature, housing 7534 can be temperature controlled by any suitable heat exchanging and temperature controlling apparatus.

In one embodiment, a mechanism is provided for slicing beef patties from a continuous stream of grinds, allowing slicing of individual patties to occur while the stream of grinds is stationary relative to the knife. This can be achieved by moving the slicing mechanism parallel with and at the same speed as the stream of grinds and slicing while in motion followed by rapid return of the slicing mechanism to an original position in readiness for subsequent slicing. However, this can be difficult to control and high production output is generally not possible. In one embodiment, the stream of grinds 7506 is halted at the time of slicing. The velocity of stream 7506, at the exit point 7522 can be adjusted between a maximum rate of flow that is substantially determined by the speed of rotation of screw 7508, and zero velocity by controlled activation of piston 7514. This may be achieved by activating piston 7514, so that it moves, at a controlled rate, away from the housing 7534 and therefore increasing the available volume within cylinder 7512 that can be filled with grinds transferred by screw 7508 and momentarily at a rate equal to the transfer of grinds through housing 7534. This arrangement can provide a momentary reduction of flow and halting of stream of grinds 7506 at exit point 7522. In order to achieve this, and ensure that there is no movement of said stream of grinds at exit point 7526, the rate of increase in available volume in cylinder 7512 must be equal to the volumetric rate of flow of stream of grinds 7506. Therefore, by activating piston 7514 in a reciprocating manner, grinds can be intermittently accommodated within space 7510, in cylinder 7512 and then immediately expelled therefrom in a continuously repeated cycle. In this way, the velocity of stream of grinds 7506, can be intermittently varied between a maximum rate of flow and substantially no rate of flow, by adjusting the flow rate provided by rotation of screw 7508 in concert with the cyclical reciprocating motion of piston 7514. Furthermore, additional piston and cylinder assemblies may be installed to provide larger capacities of volumetric variation in space 7510 and to vary the quantity of grinds extruded during each flow cycle from the exit end of conduit 7526 at 7522. Any quantity of grinds extruded during each piston 7514 cycle can be arranged to be equal to the desired weight of a single beef pattie. This cycle rate may be arranged to exceed 500 cycles per minute and, for example, if it is desired to produce quarter pound beef patties, at this rate of 500 CPM, a total rate of production would be equal to 125 lbs. of patties per minute.

Referring now to FIG. 2, a cross section through an apparatus intended for use in slicing extruded streams of ground meats, as described above in FIG. 1 to produce patties, is shown. Any suitable cutting blade may be used to slice from a continuously extruded section 7564, such as a high-speed, band blade that is driven by a suitable electric motor. A temperature controlled conduit, 7560, with flange 7562, is arranged so that it can be mounted directly to the flanges 7520, of the apparatus shown in FIG. 1. An arrow 7566 shows the direction of flow of a stream of grinds 7564 transferred from conduit 7526, via orifice 7522 into conduit 7560. Conduit 7560 may be provided in any suitable length 7538, and can be arranged with temperature controlling conduits 7540 imbedded in the walls of conduit 7560. Any suitable liquid that will remain liquid at a selected temperature may be transferred through conduits 7540 at a flow rate that will ensure temperature control of stream 7564 as may be required. A knife cutting blade 7542 with suitably machined bearing attachment 7554 is shown mounted to a driving shaft 7556. Conduit 7560 is mounted at a convenient angle and adjacent to revolving blade 7542 such that as blade 7542 is rotated, patties can be sliced from stream of grinds 7564 and deposited into stacks of sliced patties shown as 7544 and 7548. In this way, patties can be produced, stacked and transported to a packaging station via conveyor belting 7550 that is driven intermittently by a drive roller 7552 in a direction shown by arrow 7546.

Referring to FIG. 1, in order to minimize accumulation of fat and/or ice on the internal surfaces of conduit 7526, scrapers (not shown) may be mounted, for example to the end of screw 7508 to scrape internal surfaces thereof. Additionally, internal conduit surfaces may be treated with non-stick surfaces that are resistant to any such build up of fat and/or ice. Furthermore, separate temperature zones may be arranged such that, for example, housing 7534 may be maintained at 29.5 degrees F. and any suitable insulation provided at the connection between conduits 7526 and 7560. In this way conduit 7560 may be set at a much lower temperature such as 10 degrees F. so as to cause a “crust” freezing of the external surface of stream of grinds 7564 and thus provide an improved condition for slicing by knife 7542. The intermittently varied velocity of stream of grinds 7564 can be directly and correspondingly integrated with each revolution of knife 7542 such that during the knife cutting action of stream 7564, the velocity of stream 7564 is reduced to virtually zero and then as the knife rotates through an arc away from the stream 7564 and toward the next slicing of the subsequent pattie, the velocity of stream 7564 can be accelerated then decelerated so as to be again in a substantially stationary position for subsequent slicing by said knife 7542. Control of stream 7564 flow rate is therefore provided by the reciprocating action of piston 7514.

Referring now to FIG. 4, a side elevation of an apparatus assembled to continuously produce fine ground boneless beef 7630, from coarse ground boneless beef 7602 in an enclosed system that substantially excludes oxygen, is shown. Coarse ground beef 7602 is transferred through conduit 7640 to fine grinder 7608. Flanges 7604 and 7606 are fixed together to provide a gas and liquid tight seal there between allowing continuous transfer of pressurized coarse ground beef 7602 to fine grinder 7608. Ground beef 7602 and 7630 can be maintained at a selected temperature such as 29.5 degrees F. Fine ground beef 7630 is then transferred into vessel 7618 from grinder 7608, and allowed to accumulate therein. A connection to vessel 7618 from a gas source, via a pipe 7634 provides a conduit to deliver suitably pressurized gas such as carbon dioxide into vessel 7618 and to allow contact of selected gas with grinds 7630. Also, a conduit 7614 allows controlled release of excess gas that may accumulate in vessel 7630, for example via controlled pressure release valves (not shown) installed in conduit 7614. In this way a selected gas such as carbon dioxide can be provided in any free space in vessel 7618, at a constant, selected gas pressure. Positive displacement pump 7628, is driven via shaft 7626, that in turn is driven by a servo electric motor (not shown) or other such suitable variable drive motor and in such a manner as to allow adjustment, as required, to the rate of pumping of fine grinds 7630 from vessel 7618 into conduit 7620. Pump 7628, may also provide a controlled pressure inducing feature by its pumping action of fine ground beef 7630 into conduit 7620 thereby causing substantially all gaseous voids, contained in ground beef 7630, to be eliminated by dissolving of any free CO₂ gas contained therein. In this way, grinds 77 that may contain voids or spaces filled with CO₂ can be transferred to a solid stream of grinds 7624 that is substantially free of any voids. Solid stream of grinds 7624 may be transferred in the direction shown by arrow 7622 to directly connect to conduit 7502 shown in FIG. 1.

The aforementioned method and apparatus for the processing of meats refers not exclusively but most preferably to ground meats that can be pumped via a single or several positive displacement pumps. In many other applications, production of meat food products, that involve slicing of large pieces of beef, is required. It has been determined by the present inventor, that preventing contact of the freshly cut beef surface with atmospheric air can provide enhancement of storage life. Consumers, in general, will only buy red meat and therefore to accommodate the needs of the consumer and the requirements of the meat packer, the present invention is directed at providing an improved process whereby meat is sliced by automatic apparatus, directly into an enclosure that excludes air (and oxygen). In another embodiment, apparatus shown in FIG. 5 and described in the following disclosure, provides an apparatus that can slice primal beef portions directly into an enclosure with an oxygen free gas therein, is detailed.

Referring now to FIG. 5, a round cross sectional conduit 7702 is horizontally disposed and mounted with an exit end 7718 directly adjacent and above an end of a conveyor 7726, that is mounted at an elevating angle to the horizontal. The conveyor elevating angle is set such that slices of meat will be urged forward by the action of blade 7732 as it rotates and descends, slicing through the primal so that the sliced and separated portion will fall gently onto the conveyor 7726. Enclosure 7722 can be filled with carbon dioxide gas or other suitable gas that is held at a suitable temperature and gas pressure above ambient atmospheric pressure and in such a manner to ensure that substantially no air and most importantly, no atmospheric oxygen can enter enclosure 7722. The profile of conduit 7702 may be chosen to suit any particular product which may not be round and for example, a square or rectangular profile may be chosen, however, in this instance a round profile has been shown. A blade 7732 attached to a shaft 7734 is conveniently mounted at the exit end 7718 of conduit 7702 such that slices 7728 can be cut from the end of primal 7738 after emerging from conduit 7702. Blade 7732 can be arranged to cut a single slice during a single revolution of shaft 7734. Therefore the intermittent sequencing of firstly driving blade 7732 for a single revolution to cut a single slice, followed by the measured and controlled movement of a primal such as 7738 from the exit end 7718 of conduit 7702 can be arranged to automatically and continuously operate. Slices can then be carried forward in a continuous or intermittent and controlled action for further processing or packaging, along conveyor driven in the direction shown by arrow 7724, by roller 7730.

Plugs 7704, 7708 and 7714 are shown in cross section and located on the inside of conduit 7702 between primal beef portions 7738. Primal beef portions 7738 may have been previously processed and allowed to set in a mold, after pre-rigor mortis harvesting from a slaughtered animal, such that the cross sectional dimensions of the molded primal corresponds substantially with the cross section of conduit 7702. This method of molding primal cuts of meat has previously been described in the inventor's earlier patent disclosures and while the primal cuts can vary in size, molds can be arranged such that only those dimensions shown by numbers 7744 and 7746 will significantly vary. In this way, primal cuts of meat may be located into the entry end of conduit 7702 and in the direction shown by arrow 7700. After locating a primal 7738, into the entry end of conduit 7702 a plug such as 7704 is then loaded directly behind the primal 7738 followed by another primal and then another plug such that a continuous sequence of primal cuts, with a plug interposed between each primal. Each plug such as 7704 comprises a profiled “piston” with an iron core 7736 enclosed in a plastic frame 7710. Each iron core 7736 may be magnetized to such an extent that, when a suitably mounted electromagnet is adjacent thereto a magnetic bond is developed between the iron core 7736 and the electromagnet that is substantially unbreakable by any force that is likely to be applied to either part. Frame 7708 is arranged with one or more flexible lips 7710 that can sealingly contact the inner surface of conduit 7702 but allow plugs 7704 to slide along the internal surfaces of conduit 7702, flexible lips 7710 can thereby provide a seal around the full perimeter of plug 7704 with conduit 7702 and can therefore act as a piston held captive within the conduit 7702. A series of electromagnetic rings 7742, are mounted to a drive mechanism (not shown) and each electromagnet is “mated” with a single plug such as 7704, located on the inside of conduit 7702. The distance between each plug such as 7704 can be electronically measured by proximity devices conveniently mounted external to the conduit 7702 and adjacent thereto and in such a manner so as to allow measurement of any distance between any two plugs. In this way, any particular primal cut of beef can be measured and with suitable computer apparatus arranged and connected to any suitable measuring arrangement such as said proximity switches, a selected quantity of slices can be automatically calculated and subsequently sliced as the primal emerges from the exit end of conduit 7702 by knife blade 7732. A thin section of sliced meat from each end of each primal can be removed and the balance divided into a quantity of slices having a desirable thickness. Alternatively, the length of each primal can be divided into a selected number of slices with a thickness automatically calculated, accordingly. Alternatively, slices of a chosen weight may be calculated by computer apparatus. In all cases, the primal cuts can be automatically and intermittently transferred along conduit 7702 with each forward movement of electromagnets 7742, which carry plugs such as 7704 forward simultaneously. In this way, the thickness of any slice cut by knife 7732 can be determined by the distance of each forward movement of electromagnets 7742. As plugs, such as 7704, are carried forward and emerge from exit end 7718, the operation of blade 7732 can be arranged to allow the automatic removal of each plug and subsequent transfer to the entry or loading end of conduit 7702 in readiness for its next use. Plugs can be sanitized prior to next use as may be required.

Conduit 7702 can be temperature controlled by any suitable method which may be provided by circulating liquid, such as glycol, through conduits provided within or in contact with the walls of conduit 7702, and the internal surface of conduit 7702 may be treated so as to resist “sticking” to anything passed there through. In this way, primal portions of beef may be “crust frozen” during transfer through conduit 7702. One or more conduits, such as 7740, may be provided to connect a vacuum, gas or selected agent source directly to conduit 7702.

Perishable food products produced, in part or otherwise, in the manner described herein may be placed in any suitable tray with or without any suitable substance and over wrapped with any suitable web of material such as pPVC and then placed in a master container that may be manufactured from a substantially gas barrier material or partial gas barrier material to provide finished packages. Following this, finished packages may be stored in any suitable storage room maintained at any suitable temperature until required for sale, at which time they may be removed, labeled and displayed for sale in a retail outlet such as a supermarket.

A method according to the present invention includes grinding boneless beef directly into an enclosed chamber that has been filled with a suitable gas such as CO₂ and which substantially excludes oxygen from contacting with said ground beef. Adjusting temperature of said ground beef to a suitable temperature. Processing and mixing ground beef (meat), in a vessel or series of vessels substantially excluding oxygen, so as to blend and adjust the relative quantities of fat and muscle in the finished product to a desired ratio, while maintaining the ground beef at a suitable temperature. The ground beef can then be extruded in a stream of grinds by pumping through an enclosed conduit with an exit end and a selected cross sectional area and profile that is substantially similar to a typical beef pattie, at a velocity that is adjustable while maintaining pumping at a substantially constant rate. The stream of ground beef can be pressurized in a conduit at a selected pressure and compressing any voids such that CO₂ gas contained therein dissolves into the stream of ground beef, while continuing to maintain ground beef at a suitable temperature. The velocity of the stream of grinds can be adjusted so as to intermittently slow or stop its flow as it emerges from the exit end of the enclosing conduit and allow slicing with knife means to provide single beef patties in stacks of a chosen quantity. Intermittent slowing or stopping of flow may exceed 500 cycles per minute. The processed meat is interfaced with a packaging system, which packages the fresh meat patties without exposure to air while continuing to maintain the product at a suitable temperature.

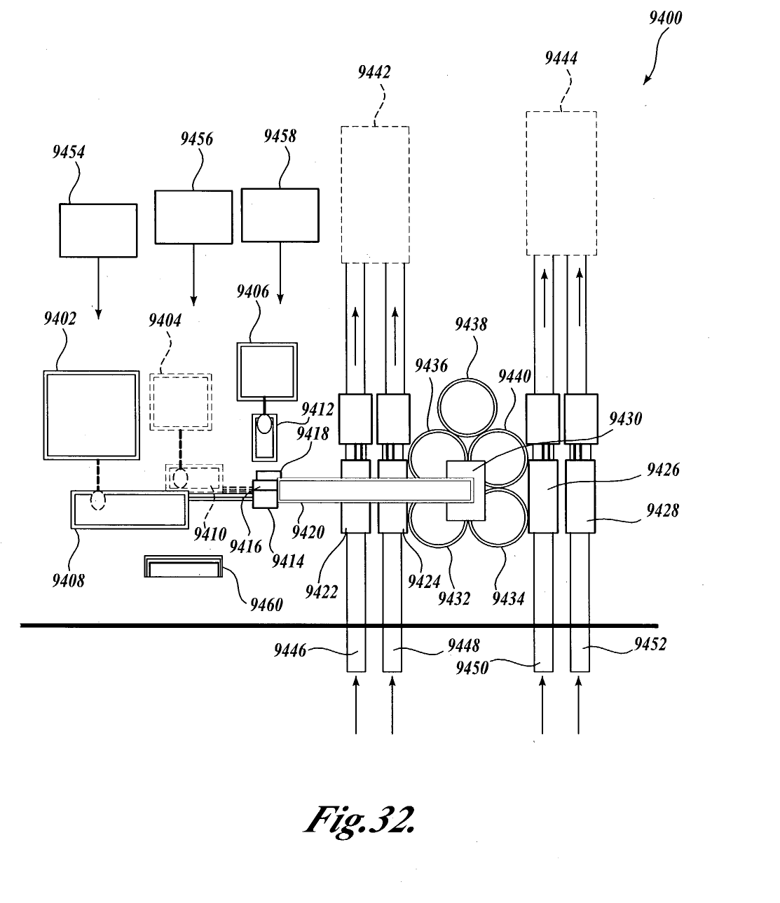

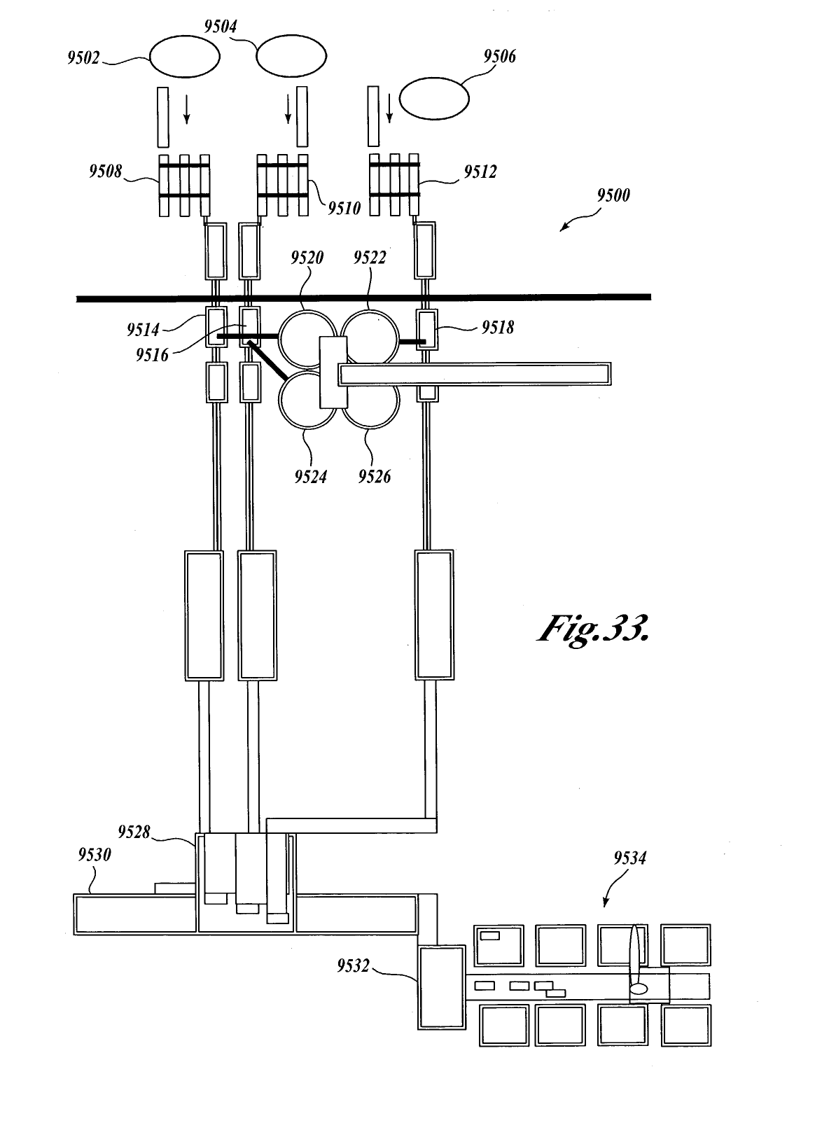

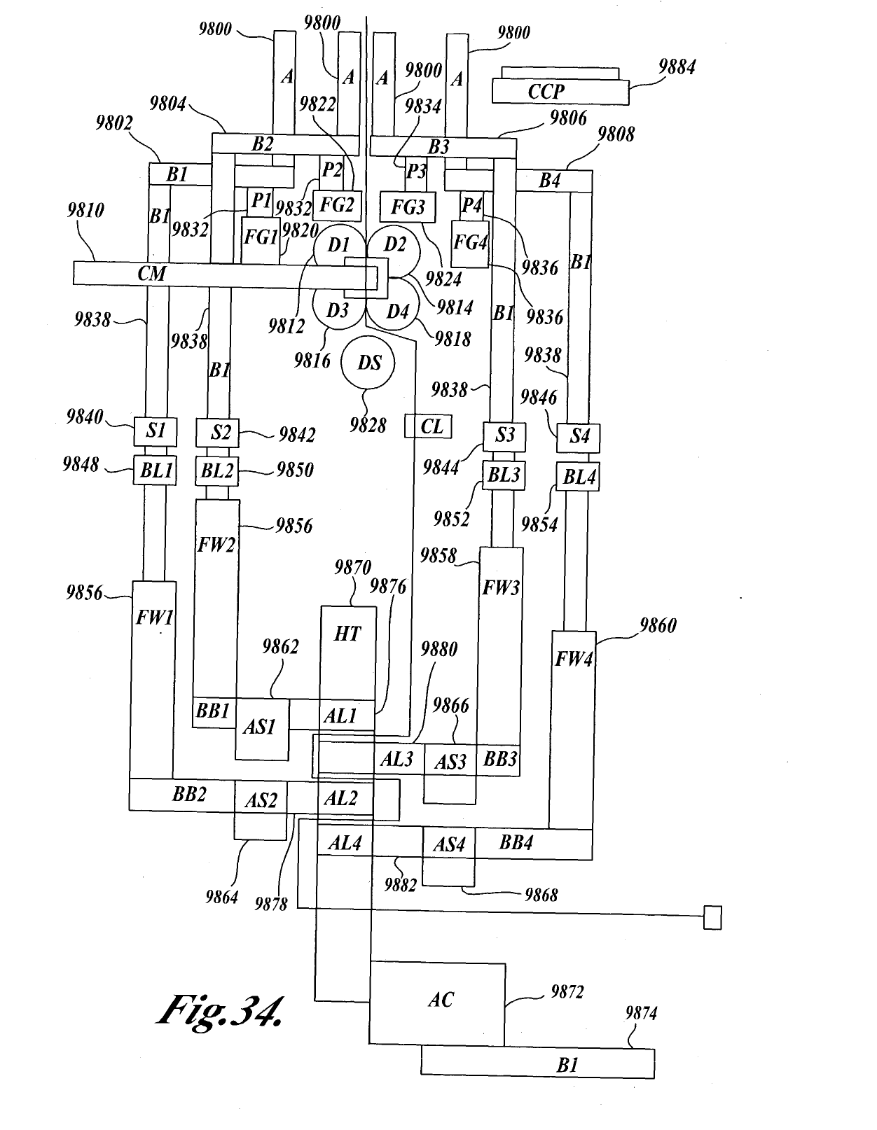

Referring now to FIG. 32, a schematic illustration of a plant layout is shown. The plant layout includes a processing stream or train, for processing meat. In one section of the plant, sources of meat 9454, 9456, and 9458 are transferred to meat grinders 9402, 9404, and 9406. A suitable supplier for meat grinders is the Weiler Company, Inc. of Whitewater, Wisconsin. The meat grinders are connected to downstream pre-blending and transfer equipment 9408, 9410 and 9412, which may include screw and/or belt conveyers and pumps as the transfer equipment. The pre-blending and transfer equipment may be supplied by the Weiler Co. and the continuous blending equipment supplied by SafeFresh Technologies, LLC of Mercer Island, Wash. The pre-blending equipment is connected to on-line measuring devices 9414, 9416, and 9418, respectively, for measuring the amount of fat to lean meat ratio. The measuring devices can be supplied by Epsilon Industrial of Austin Tex. or Holmes/Newman of Fallbrook, Calif. The transfer equipment includes positive displacement pumps supplied by the Weiler Company. Downstream from the measuring devices, the meat is transferred to continuous blending equipment, 9420 where the meat is blended in a controlled or modified atmosphere, which substantially excludes oxygen. At this point one or a plurality of meat streams can be fed into the blending equipment to provide for meat grinds of a desired constituency of fat and lean meat, therefore the continuous blending equipment includes a product entry port for one or a plurality of meat streams. The continuous blending equipment is supplied by SafeFresh Technologies, LLC, and Wenger of Sabetha, Kans. While a continuous blending process is suitable for consistency and efficiency, the ground meat can be fed in batches with holding vessels interspersed throughout the process, the meat can then transferred to one or more vessels 9432, 9434, 9436 and 9440 for temporary storage. One vessel 9438 may serve for rejects or off spec product. Temperature control by injection of carbon dioxide can be adjusted to between about 29 to about 38° F., the pressure is held to less than about 40 psi, in the continuous blending equipment and vessels but the pressure is kept to less than about 10 psi elsewhere throughout the equipment. Continuous blending equipment 9420 can be horizontally disposed and elevated to provide for a gravity feeding arrangement alternately and to either of vessels 9432, 9434, 9436 and 9440. A quantity of any specified blend of fat and lean grinds, sufficient to fill a vessel is produced followed by a quantity of another specified blend of fat and lean grinds, sufficient to fill a second vessel. Vessels can be supplied by the Weiler Company. Blended grinds are transferred from each vessel by suitable conveying and transfer equipment such as positive displacement pumps to meat portioners 9422, 9424, 9426, and 9428, where the meat is extruded and sliced into desired portions by size or weight. Feeding may be continuous or in batches as required. The packaging section of the plant includes a conveyor system 9446, 9448, 9450, and 9452 for moving unfinished webs through stations, where webs are finished into trays and loaded with goods, such as portioned meats. After the goods have been loaded into trays, the trays are sealed by a second web, such as may be provided with the Hayssen model RT1800, 9442 and 9444, with the modifications described herein above. Further packaging may include loading into master containers, depending on the circumstances and palletizing, according to a buyer's specifications. The processing of the ground meat is conducted in a controlled or modified atmosphere having little to no exposure to oxygen. Suitable gases are described in the specification. The equipment is automated and controlled by a computer 9460, such as equipment supplied by the Wenger Co. The computer can be connected to one or more buyer computers via a communication system, such as the Internet, for automatically receiving and filling orders from buyers, such as supermarkets.

Referring now to FIG. 33, a schematic representation of a packaging area of a meat processing plant is illustrated. The packaging area can include one or a plurality of processing trains. In one embodiment, the packaging area 9500 includes three sources of webs 9502, 9504, and 9506 for processing the unfinished webs. A web treatment train includes magazines 9508, 9510, and 9512 containing the webs, gas treatment and sterilizing equipment, and bonding equipment to produce the finished trays from the unfinished pre-form webs. Under some circumstances, bonding equipment may not be necessary for non-bonded trays, which can be produced by using pre-form webs not requiring bonding. There can be one or a plurality of unfinished web streams, which can produce finished webs of differing sizes as required. The equipment in this area can be supplied by PMI Cartoning Inc. of Elk Grove Village, Ill., with adhesives supplied by National Starch and Chemical (a division of the ICI Group) of Bridgewater, N.J. The tray treatment section is linked to conveyor and transfer equipment which moves individual finished trays along a conveyor, while meat grinding, portioning and loading apparatus, 9514, 9516, and 9518 processes the meat stored in vessels 9520, 9522, and 9524 which is then loaded as goods into the finished trays. The trays can then be weighed and labeled with a bar code containing relevant information. The weighing and labeling equipment can be supplied by Herbert Industrial of Haverhill, Suffolk, United Kingdom. The trays with goods are then sealed with a second web. The finished packages continue to travel on conveyors where the packages can be directed to a stacking apparatus 9528, such as drop loaders, supplied by PMI Cartoning, Inc. At the stacking apparatus, further equipment can produce thermoformed cartons. Thermoforming equipment 9530 can be supplied by Cott Technologies Inc. of La Puente, Calif. The finished packages can then be loaded and stacked into the newly thermoformed cartons. The auto carton equipment can be supplied by PMI Cartoning, Inc. The cartons are then palletized in palletizing equipment 9534 and made ready for shipment to a buyer's designated delivery destination. For the majority of the meat processing, the meat is excluded from substantial contact with oxygen to minimize oxidation. Desirable concentrations of gases are continually being used to pad processing equipment. This equipment can be supplied by the BOC Gases company. Other equipment is developed to remove undesirable gases by using vacuum equipment. Vacuum equipment can be supplied by the Kinney Co. of New York or the Reitschle vacuum pump manufacturing company of Germany. Conveyor and or transfer equipment can be supplied by PMI Cartoning, Inc. While three differing webs for trays may be provided at the loading station, each master container is provided with a manner of identifying an allocated destination. The master containers are palletized to ship where they are needed by the buyer or alternatively may be placed in storage. The computer controller is provided with a set of instructions to manage, in cooperation with the input provided by an operator interface, the processing and packaging of the meat goods.

Referring now to FIG. 34, a schematic illustration of an embodiment of a plant layout according to the present invention comprising an automated system of pre-treating packaging components and perishable goods such as ground meats is shown. The arrangement as shown includes four production lines for the portioning, loading, over-wrapping and assembly of barrier master container packages. Four empty tray conveyors are shown as 9800. Trays are transferred along conveyors 9800 to transverse conveyors 9802, 9804, 9806, and 9808. A continuous mixer 9810 is arranged to deposit selected ground beef into any one of four silos 9812, 9814, 9816, and 9818. Each of silos 9812, 9814, 9816, and 9818 is arranged with a positive displacement pump attached thereto such that ground meat can be pumped via conduits (not shown) from silo 9812 to fine grinder 9820, from silo 9814 to fine grinder 9822, from silo 9816 to fine grinder 9824, and from silo 9818 to fine grinder 9816. A dump silo 9828 is provided such that any quantities of material that are determined to be unsuitable for packaging can be transferred therein. Fine grinders 9820, 9822, 9824, and 9826 are attached respectively to portioning equipment 9830, 9832, 9834, and 9836. Empty trays transferred along conveyors 9800 are loaded with ground meat portions from portioner 9830 at conveyor 9802, from portioner 9832 at conveyor 9804, from portioner 9834 at conveyor 9806, and from portioner 9826 at conveyor 9808. Conveyors 9838 transfer loaded trays from each loading conveyor 9802, 9804, 9806, and 9808 to weighing scales 9840, 9842, 9844 and 9846, respectively. Labels with weight and product information as required, are applied to the bottom of loaded trays, by bottom label applicators 9848, 9850, 9852, and 9854, respectively. Loaded trays are then over wrapped by flow packers 9856, 9858, 9858, and 9860, respectively. Automatic stackers 9862, 9864, 9866, and 9868 stack selected groups of loaded over wrapped trays which are then transferred and automatically loaded by automatic loaders 9876, 9878, 9880, and 9882, into gas barrier containers formed in line on horizontal thermoforming machine 9870. Conveyors transfer trays from the flow packers to the automatic stackers. An automatic carton erection apparatus 9872 is arranged to enclose each barrier master container in a carton, which is then transferred to an exit conveyor 9874. A central control panel 9884 is located conveniently to allow control of the complete system. Continuous mixer 9810 and silos 9812, 9814, 9816, and 9818 may be located in an adjacent room separated by an insulated wall such that the contents of the silos can be maintained at a selected temperature which may be 34 degrees F.

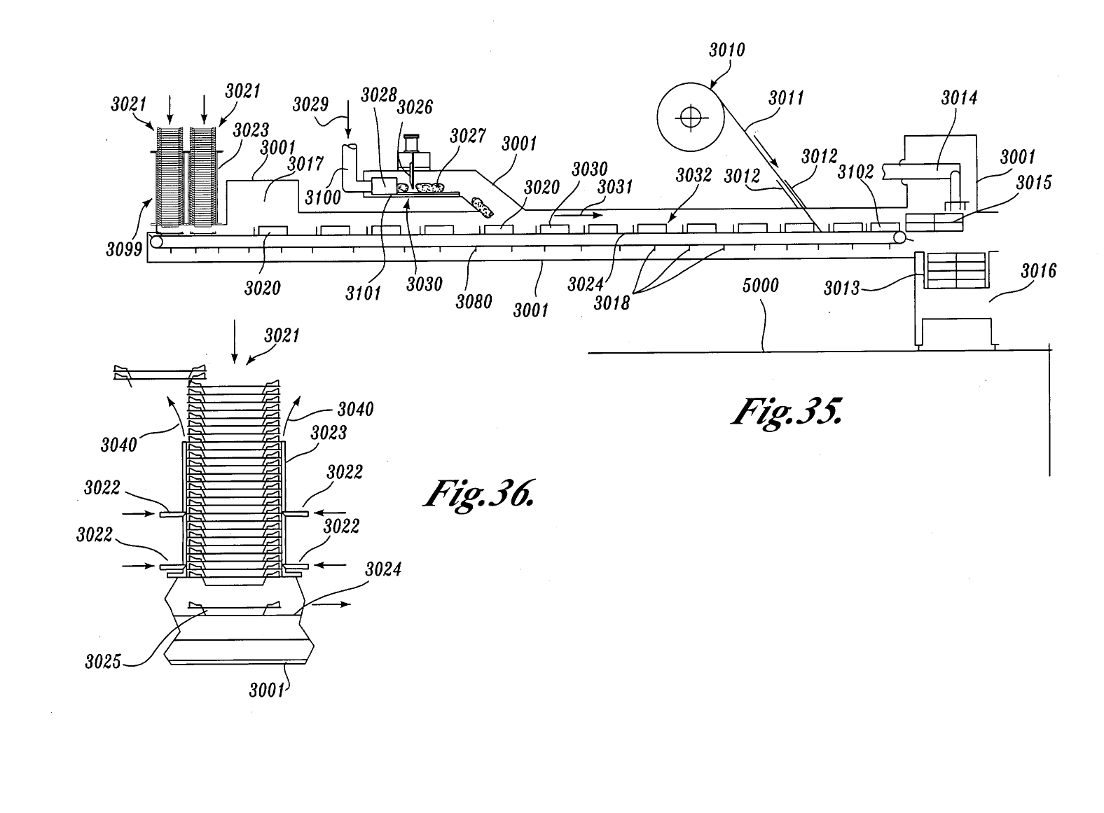

Referring now to FIG. 35, a schematic, cross sectional illustration of a section of the plant layout according to the present invention is shown. The plant is located on a factory floor, 5000, and at a convenient elevation from the floor, in an enclosed, suitably ventilated room that is temperature controlled at about 38 degrees F. A generally horizontally disposed conduit is defined by an outer, substantially gas tight, enclosure 3001. Packaging components such as tray performs 3021 and web materials 3011, and ground meat 3027 are transferred into the conduit 3001 in such a manner so as to substantially exclude the entry of atmospheric oxygen. A gas 3032 is provided in any space inside conduit 3001 that is not occupied by equipment or goods. Gas 3032 is selected and may comprise any suitable gas such as carbon dioxide or nitrogen and is maintained at a pressure above ambient atmospheric pressure. A conveyor3024 is conveniently mounted within conduit 3001 and arranged to carry trays 3020 there through. Tray pre-forms 3021 are stacked into profiled and vertically disposed magazines 3023 and 3099. Magazines 3023 and 3099 are arranged to have an outer wall that closely, but not touchingly, follows the outer profile of the stacks of pre-form trays 3021, contained therein. De-nesting mechanisms (not shown) are arranged to remove a single perform from the bottom of a stack such as contained in magazine 3023 and position it onto conveyor 3024. In this way, gas contained within conduit 3001 can then fill the cavity in tray perform and thereby substantially prevent any atmospheric oxygen or other undesirable gases from entering into the tray cavity. Tray pre-forms 3021 are then carried in the direction shown by arrow 3031 to a position below the folding and bonding arrangement not shown but housed within enclosure 3017. During the folding and bonding of pre-form 3021 to form tray 3020 gas 3032 fills all cavities or interstitial voids contained in the tray and in this way it is ensured that only a selected and suitable gas is contained therein. Finished empty trays 3020 are then placed by 3017 onto conveyor 3024 and carried forward to be loaded with portions of ground meat 3027. A stream of selected ground meat is transferred through conduit 3100 at a convenient velocity and into fine grinder 3028 and in such a manner so as to extrude a continuous and suitably cross sectional profiled stream of ground meat 3101 onto conveyor 3024. Extruded stream 3101 is extruded into conduit 3001 and onto conveyor 3024, mounted therein, at a suitable velocity so that guillotine 3026 can cut portions of substantially similarly sized ground meat sections there from. Portions of ground meat 3027 are then transferred into trays 3020, which are there together transferred through conduit 3001 on conveyor 3024. Conveyor 3024 can be arranged with upwardly disposed “cleats” 3080 or a series of suitable enclosures to ensure that when ground meat portions 3027 are loaded into trays 3020 the tray is positioned precisely beneath the respective ground meat portion, allowing accurate loading into tray 3020 to produce a loaded tray with goods 3030. Loaded trays with goods 3030 are then transferred through conduit 3001 toward over wrapping equipment arranged to over wrap trays 3030. A roll of suitable over wrapping web material 3010 is conveniently mounted above conduit 3001 and is unwound by transferring a single web of material 3011 through a slot like conduit 3012. Gas contained in conduit 3001 at an elevated pressure can pass over the surfaces of web 3011 while it passes through slot like conduit 3012 and in this way ensure that substantially no atmospheric oxygen is allowed to enter conduit 3012 or conduit 3001. Over wrapped and hermetically sealed trays 3102 are transferred along conduit 3001 toward robot stacking arrangement 3014. Robot 3014 is enclosed in a housing that forms a part of conduit 3001 and is programmed to stack trays 3102 into groups 3015 that are then loaded into gas barrier containers 3013. Gas barrier containers 3013 can be formed in line and flushed with a suitable gas prior to loading of stacks 3015 therein. Horizontal thermoforming machine 3016 is conveniently located below robot 3014 and is arranged so that the thermoformed barrier containers 3013 are enclosed within an extension of conduit 3001 and thereby ensuring that gas 3032 is in contact therewith and filling cavities in barrier containers 3013.

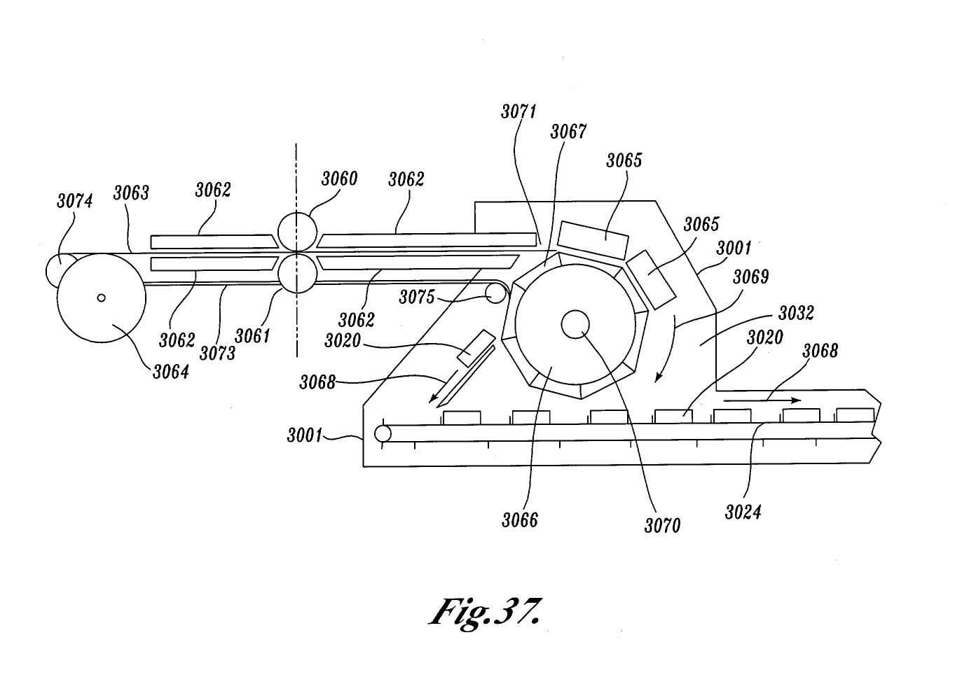

Referring now to FIG. 36 the tray de-nesting apparatus portion of FIG. 35, before the pre-form flaps have been bonded to the tray walls, is shown in a cross sectional view. Vertically disposed walls 3023 are arranged to closely conform to the outer edge perimeter of the stacked pre-forms 3021. A narrow gap is thereby maintained between the stack 3021 and magazine walls 3023 allowing the tray pre-forms to slide through the magazine without restriction, as the lowest tray performs are progressively removed and placed onto conveyor 3024. Gas from conduit 3001, is exhausted through the narrow gap at 3040 and additional selected gas can be injected through conduits 3022 at a suitable pressure so as to substantially fill spaces between the stacked pre-forms as they are gradually transferred through magazine 3023.

Referring now to FIG. 37, a schematic illustration of an embodiment of a specially arranged thermoforming apparatus is shown according to the present invention. The apparatus shown in FIG. 37 is intended to provide an alternative, economical method of delivering trays to conveyor 3024 as shown in FIG. 35. A wheel 3066 is mounted onto a shaft 3070. Wheel 3066 is arranged to have 8 flat sides, onto which tooling 3067 can be mounted. Wheel 3066 is attached directly to a sprocket (not shown), which engages with a pair of continuous gripper chains 3073. Other sprockets including idler sprockets 3075 and drive sprockets 3074 are mounted to maintain gripper chains 3073 follow a fixed and generally horizontally disposed track. A roll of interchangeable and thermo-formable material 3064 is located between chains 3073 and is unwound in a continuous web of material 3063. As web 3063 is unwound from roll 3064 it is held by gripper chains 3073 at each side edge and withdrawn, at a suitable rate, from roll 3064 by the forward motion of chains 3073. Sprockets 3074 are attached to a suitable drive motor with controller that progressively carries web 3063 between heat banks 3062. Heat banks 3062 are mounted in close proximity above and below web 3063 and as gripper chain 3073 carries web 3063 there between, the web is heated. The temperature of heat banks 3062 is controlled and maintained within a selected range so as to ensure that the temperature of web 3063 is at a thermo-formable temperature as it passes from between heat banks 3062 and onto a face of wheel 3066. Rollers 3060 and 3061 are arranged to contact the upper and lower surfaces of web 3063 and apply a calendering pressure thereto. Rollers 3062 and 3061 are maintained at a temperature as required. Eight sets of tools 3067 are mounted to wheel 3066. Each tool 3067 comprises a four-sided tray cavity forming depression with a flat forming depression adjacent to each side, such that a pre-form with four flaps can be formed therein. Clamping fixtures with plugs or matching molds 3065 are arranged to conveniently be incorporated as required while the pre-form being formed in matching tools 3067. Forming tool 3067 can be arranged such that the flap forming sections of the tool can be hinged so as to fold the flaps after cutting from web 3063, and become bonded to walls of the tray cavity prior to ejection. In this way, a pre-form tray can be thermoformed, cut from the web 3063, folded and bonded, and ejected by tools on wheel 3066. A finished tray 3020 is then ejected and allowed to fall in the direction as shown by arrow 3069, onto conveyor 3024. Enclosure 3001 is arranged to completely enclose the wheel assembly 3066, clamping arrangements 3065 and conveyor 3024, and in such a manner to ensure that all cavities between walls and flaps of tray 3020 are filled with selected gas 3032. Web 3063 may comprise a solid extruded sheet of plastics material, extruded from any suitable polymer, with an additive contained therein that will generate a suitable gas such as carbon dioxide when heated to a thermo-formable temperature. Web material 3063 may comprise a polypropylene polymer with any suitable additive such as a filler additive containing calcium bicarbonate that will release carbon dioxide gas when heated, within the extruded polymer sheet, to a thermo-formable temperature. In this way, an expanded polypropylene sheet (EPP) of material can be formed immediately prior to use, and ensuring that carbon dioxide gas fills the interstitial spaces within the web material from which trays 3020 are formed.

Any suitable substance, gas, blend of gases, solution or agent may be substituted, included as an alternative or included with any suitable gas or blend of gases that has been specified for any use or application in this disclosure.

Modifications may be made to the inventions as would be apparent to persons skilled in the packaging arts. These and other modifications may be made without departing from the ambit of the invention, the nature of which is to be determined from the foregoing description.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method of irradiating food, comprising:
grinding the food in an environment having an oxygen level lower than the oxygen level of air, irradiating the food in an environment having an oxygen level lower than the oxygen level of air, and packaging the food in a package in an environment having an oxygen level lower than the oxygen level of air.

2. The method of claim 1, wherein irradiating is done using an electron beam.

3. The method of claim 1, wherein the food comprises oxidizable compounds.

4. The method of claim 1, wherein the food comprises fat.

5. The method of claim 1, wherein the environment comprises carbon dioxide or nitrogen.

6. The method of claim 1, wherein the oxygen content of the environment is less than 5%.

7. The method of claim 1, wherein the oxygen content of the environment is less than 500 ppm.

8. The method of claim 1, further comprising adding an oxygen absorber to the package.

9. The method of claim 1, further comprising maintaining the temperature of the food above the freezing point of the food during grinding, irradiating, and packaging.

10. A method of irradiating food, comprising:
grinding the food in an environment having an oxygen level lower than the oxygen level of air and irradiating the food in an environment having an oxygen level lower than the oxygen level of air.

11. The method of claim 10, wherein irradiating is done using an electron beam.

12. The method of claim 10, wherein the food comprises oxidizable compounds.

13. The method of claim 10, wherein the food comprises fat.

14. The method of claim 10, wherein the environment comprises carbon dioxide or nitrogen.

15. The method of claim 10, wherein the oxygen content of the environment is less than 5%.

16. The method of claim 10, wherein the oxygen content of the environment is less than 500 ppm.

17. The method of claim 10, further comprising maintaining the food at a temperature that is above the freezing point of the food during grinding and irradiating.

18. A method of irradiating an object, comprising:
irradiating the object in a environment having an oxygen level lower than the oxygen level of air.

19. The method of claim 18, further comprising packaging the object in a package in an environment having an oxygen level lower than the oxygen level of air.

20. The method of claim 19, further comprising maintaining the object at a temperature that is above the freezing point of the object during irradiating and packaging.

21. The method of claim 18, wherein irradiating is done using an electron beam.

22. The method of claim 18, wherein the object comprises oxidizable compounds.

23. The method of claim 18, wherein the object comprises fat.

24. The method of claim 18, wherein the object comprises beef.

25. The method of claim 18, wherein the environment comprises carbon dioxide or nitrogen.

26. The method of claim 18, wherein the oxygen content of the environment is less than 5%.

27. The method of claim 18, wherein the oxygen content of the environment is greater than 5 ppm.

28. The method of claim 18, further comprising maintaining the object at a temperature that is above the freezing point of the object during irradiating.

29. The method of claim 18, further comprising packaging the object in a package in an environment having an oxygen level greater than the oxygen level of air.

30. The method of claim 29, wherein the oxygen content of the packaging environment is greater than 40% by volume.
